(19) United States
(12) Patent Application Publication
(10) Pub. No.: US 2019/0026791 A1
(43) Pub. Date: Jan. 24, 2019

(54) AUTOMATED SYSTEM FOR COORDINATING TARGETED CHARITABLE RELIEF AID

(71) Applicant: Walmart Apollo, LLC, Bentonville, AR (US)

(72) Inventors: Sharad K. Rai, Bentonville, AR (US); Sylvia Jennifer Parker, Rogers, AR (US); Walter Soto, Centerton, AR (US); Steven Andrew Ayers, Rogers, AR (US); Nicholaus A. Jones, Fayetteville, AR (US)

(21) Appl. No.: 16/028,514

(22) Filed: Jul. 6, 2018

Related U.S. Application Data
(60) Provisional application No. 62/535,205, filed on Jul. 20, 2017.

(51) Int. Cl. G06Q 30/02; H04L 29/06

(52) U.S. Cl. CPC G06Q 30/0279; H04L 63/10

(57) ABSTRACT

Examples provide a system for pre-staging items for coordinated charitable aid. The system predicts aid opportunities associated with predicted future events in a selected geographic area. The system assembles a list of items predicted to be requested for relief aid if the predicted future event occurs. The identified items are pre-staged within the selected geographic area or within a predetermined distance of a location of the predicted event prior to occurrence of the event. If the event occurs, the list of pre-staged items is provided in response to verified aid request associated with a charitable aid opportunity using data gathered from a plurality of sources and aid request rules or made available on an aid request website for donation to the aid opportunity. The aid request generator updates the list of pre-staged items and generates notifications to the requesting charity when pre-staged items are ready for pick-up or delivery.

### BACKGROUND

During natural disasters and other emergencies, it is very important to be able to get medical supplies, food, clean drinking water, and other necessities to the impacted areas as quickly and efficiently as possible to assist victims, relieve suffering, and assist with recovery. Frequently, when disaster strikes one area, people in other areas are eager and willing to help by purchasing needed supplies and other relief aid for the victims. However, these willing donors are frequently unable to help because they do not know what items are needed by the charities working in those disaster areas. Even if a charity successfully publicizes their needs, those willing to make donations of needed items often do not know where to purchase the needed items and they do not know where to donate the items. Due to this lack of information, many needed goods and other supplies that would have willingly been purchased for a charity or relief organization remain un-purchased. Charities capable of delivering and/or distributing needed items to those in need may fail to obtain the needed supplies when they are most needed. Moreover, when needed supplies are available, roads and other transportation routes into the affected areas may be congested or inaccessible due to adverse weather or other conditions.

### SUMMARY

Examples of the disclosure provide a system for coordinating targeted charitable aid. The system includes a memory; at least one processor communicatively coupled to the memory; and a plurality of data sources generating dynamic context data associated with a selected geographic area. An aid opportunity prediction component analyzes the dynamic context data obtained from the data sources and historical event-related data associated with the selected geographic area using pattern analysis. The aid opportunity prediction component generates a predicted future event within the selected geographic area and a predicted time-period for pre-staging items prior to occurrence of the predicted future event based on the analysis results. An analysis component identifies a predicted aid opportunity associated with the predicted future event and an aid opportunity type of the predicted aid opportunity. An item identification component generates a list of recommended items predicted to be requested on condition the predicted future event transpires within the predicted time-period based on historical requested items associated with historical events of the predicted aid opportunity type. A location identification component identifies a pre-staging location within a predetermined distance from the selected geographic area. A pre-staging component routes a set of items identified in the list of recommended items to a storage area associated in the identified pre-staging location during the predicted time-period. A verification component analyzes sensor data generated by a set of sensor devices associated with the pre-staging location to verify the set of items are present within the storage area.

Other examples provide a computer-implemented method for coordinating targeted charitable aid. An aid opportunity prediction component obtains dynamic context data from a plurality of data sources via a network. The aid request generator analyzes the dynamic context data and historical event-related data associated with a selected geographic area using pattern analysis. The aid request generator generates a predicted future event within the selected geographic area and a predicted time-period for pre-staging items prior to an occurrence of the predicted future event. An analysis component identifies a predicted aid opportunity associated with the predicted future event and an aid opportunity type of the predicted aid opportunity. An item identification component generates a list of items predicted to be requested on condition the predicted future event transpires within the predicted time-period based on previous requested items associated with historical events of the identified aid opportunity type. A location identification component identifies a pre-staging location within a predetermined distance from the selected geographic area. A verification component verifies pre-staging of the set of items within the storage area at the identified pre-staging location within the predicted time-period based on sensor data obtained from a set of sensor devices associated with the pre-staging location.

Still other examples provide a system for pre-staging items for targeted charitable aid. The system includes a memory; at least one processor communicatively coupled to the memory; a plurality of data sources generating dynamic context data associated with a selected geographic area. An aid request generator component analyzes the dynamic context data to identify an aid opportunity and an aid opportunity type. A communications interface device outputs a list of recommended items for pre-staging in preparation for an occurrence of the aid opportunity based on the identified aid opportunity type. A pre-staging component routes a set of items identified in the list of recommended items to the storage area associated with a pre-staging location within a predetermined distance of a predicted location for the predicted future event for storage during a predicted pre-staging time-period prior to occurrence of the predicted future event.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing device for pre-staging items for targeted charitable aid.

FIG. 2 is an exemplary block diagram illustrating a server for generating requests for needed items associated with a charitable aid opportunity.

FIG. 3 is an exemplary block diagram illustrating a server for receiving a request for needed items associated with a charitable aid opportunity.

FIG. 4 is an exemplary block diagram illustrating a verification component for authenticating a charitable aid opportunity.

FIG. 5 is an exemplary block diagram illustrating an aid request generator for predicting future charitable aid opportunities.

FIG. 6 is an exemplary block diagram illustrating an aid request generator for pre-staging recommended items for predicted aid opportunities.

FIG. 7 is an exemplary block diagram illustrating a pre-staging location associated with a predicted aid opportunity.

FIG. 8 is an exemplary block diagram illustrating a data storage device storing data associated with one or more charitable aid opportunities.

FIG. 9 is an exemplary flow chart illustrating operation of the computing device to update a requested items list for a verified charitable aid opportunity.

FIG. 10 is an exemplary flow chart illustrating operation of the computing device to identify providers of requested items.

FIG. 11 is an exemplary flow chart illustrating operation of the computing device to pre-stage recommended items for a predicted future event.

FIG. 12 is an exemplary flow chart illustrating operation of the computing device to verify pre-staging of recommended items in a pre-staging location.

FIG. 13 is an exemplary flow chart illustrating operation of the computing device to authenticate a charitable aid opportunity.

FIG. 14 is an exemplary flow chart illustrating operation of the computing device to generate a requested items list for a verified charitable aid opportunity.

Corresponding reference characters indicate corresponding parts throughout the drawings.

### DETAILED DESCRIPTION

Referring to the figures, examples of the disclosure enables a system for coordinating pre-staging of items to provide targeted charitable aid. The system analyzes data associated with a selected geographic area, such as historical weather data, to predict future events. The future events may include extreme weather events, holidays, seasonal activities or any other event. A weather event may include, without limitation, a flood, hurricane, structural fire, forest fire, drought, icy conditions, heavy snow fall, freezing temperatures, earthquake, tornado, volcano eruption, or other natural disaster resulting in property damage or disruption of transportation or other services may create an aid opportunity.

The system identifies items which are predicted to be needed or useful in response to the predicted event. The system pre-stages the recommended items within a predetermined distance or range of the predicted event. In this manner, the items are on-hand at or near the location of the event for faster response time, improved item transportation logistics, etc. Pre-staging items enables provision of necessary supplies quickly and efficiently regardless of weather conditions or conditions of roads or other transportation modes. Thus, even if roads are flooded or otherwise inaccessible, supplies likely to be requested in response to a natural disaster or extreme weather emergency are pre-staged for ease of access by charitable aid agencies and/or emergency responders.

In some examples, an aid request generator obtains data associated with an identified aid opportunity which has already occurred from a plurality of data sources. An aid opportunity is an event or occurrence which creates a need for charitable aid in a location or region.

The aid request generator in some examples analyzes the data to verify occurrence of the aid opportunity. This enables the system to determine if a request for donations is a legitimate request for aid by a verified charity to avoid fraudulent or frivolous donation requests. This improves the effectiveness of donations and maximizes assistance to legitimate charities.

Other examples provide an aid request generator that analyzes aid opportunity data and historical aid opportunity data to generate a predicted list of needed items for a given aid opportunity. This enables quick, efficient, and accurate acquisition and provision of needed items customized for an identified aid opportunity.

In yet other examples, a user interface component outputs a recommended items list to one or more users. The recommended items list is a list of items predicted to be needed in response to the predicted event or otherwise recommended for pre-staging. The one or more users purchase selected items for donation to a verified aid opportunity. The aid request generator in these examples notifies a provider of the purchased selected items for delivery of the selected items to a receiving party associated with the aid opportunity. In this manner, a user in one location purchases items for receipt by a verified charity in a different location. This enables a user to donate needed items for a relief effort in a remote location from the user while ensuring the donations reach the appropriate parties in a timely manner to provide comfort and aid to those in need.

The aid request generator in some examples coordinates verifying a need, identifying items to meet the need, obtaining donations of the needed items, locating providers in proximity of the location of the aid opportunity capable of providing the obtained needed items, and predicting future needed items for predicted future aid opportunities. This enables fast and efficient coordination of charitable relief aid resources for improved assistance to legitimate charities, increased speed in providing aid, and reduced costs associated with obtaining donations.

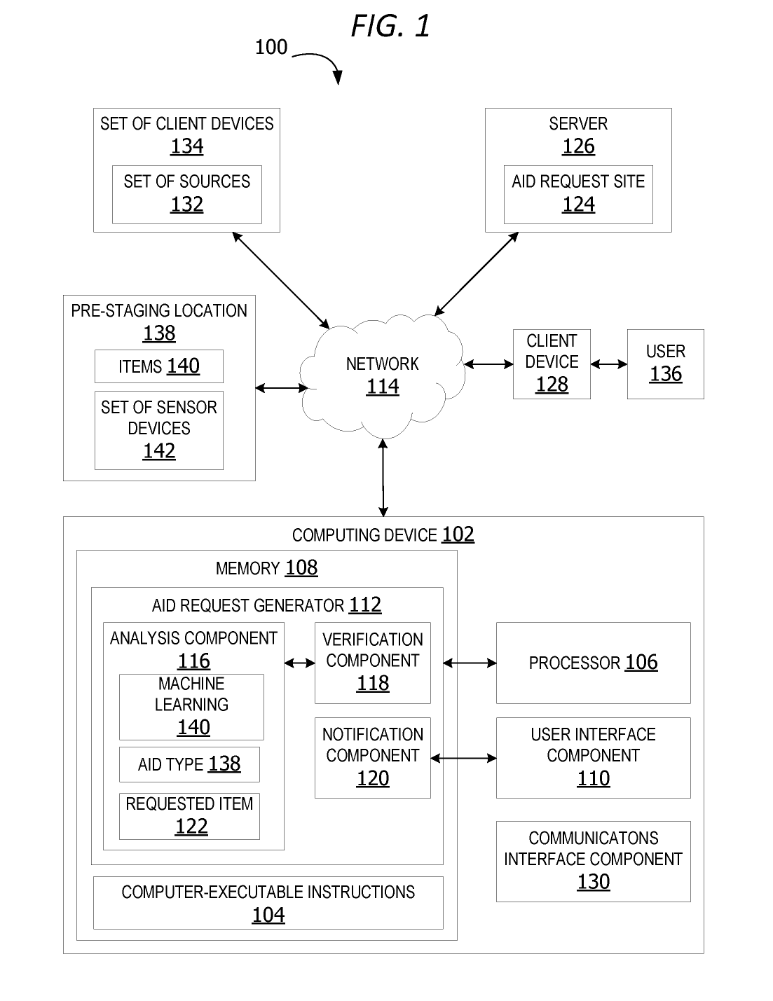

Referring to FIG. 1, an exemplary block diagram illustrates a system 100 for coordinating targeted charitable aid. In the example of FIG. 1, the computing device 102 represents a system for verifying aid opportunities and generating aid requests for the verified aid opportunities. The computing device 102 represents any device executing computer-executable instructions 104 (e.g., as application programs, operating system functionality, or both) to implement the operations and functionality associated with the computing device.

The computing device 102 may include a mobile computing device or any other portable device. In some examples, the mobile computing device includes a mobile telephone, laptop, tablet, computing pad, netbook, gaming device, and/or portable media player. The computing device 102 may also include less portable devices such as desktop personal computers, kiosks, tabletop devices, industrial control devices, wireless charging stations, and electric automobile charging stations. Additionally, the computing device 102 may represent a group of processing units or other computing devices.

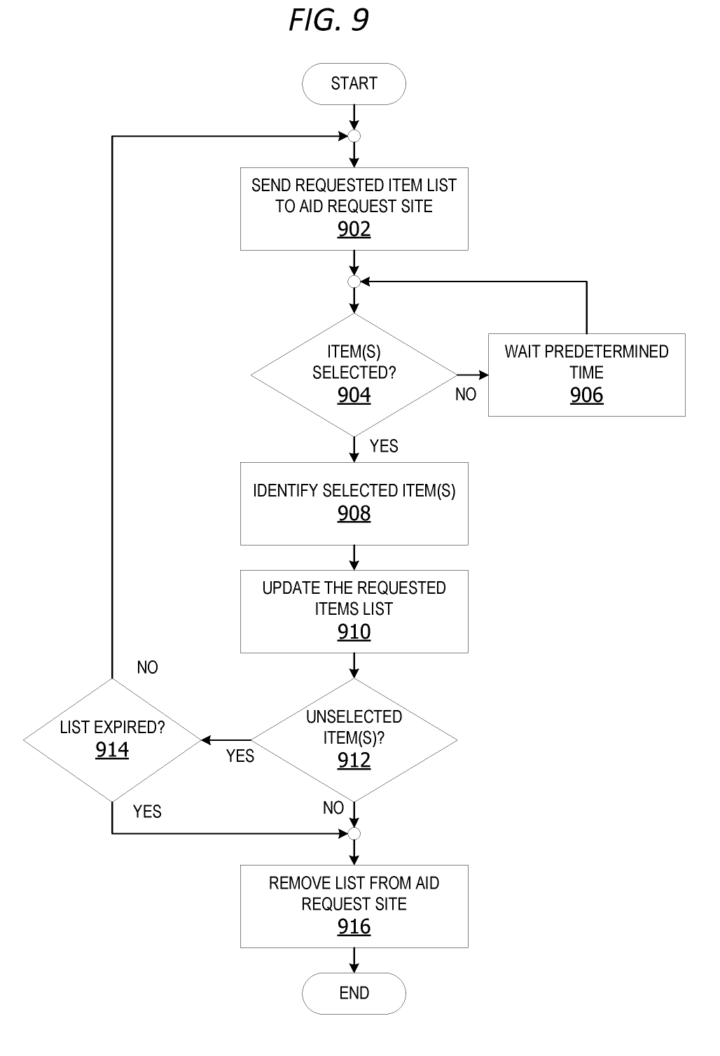

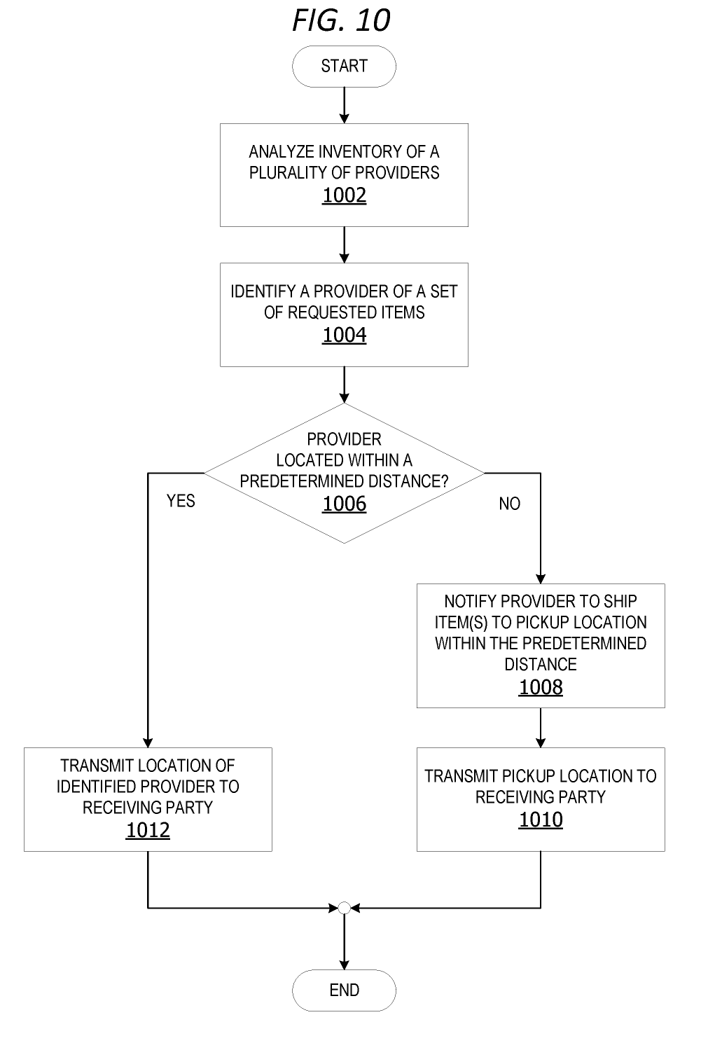

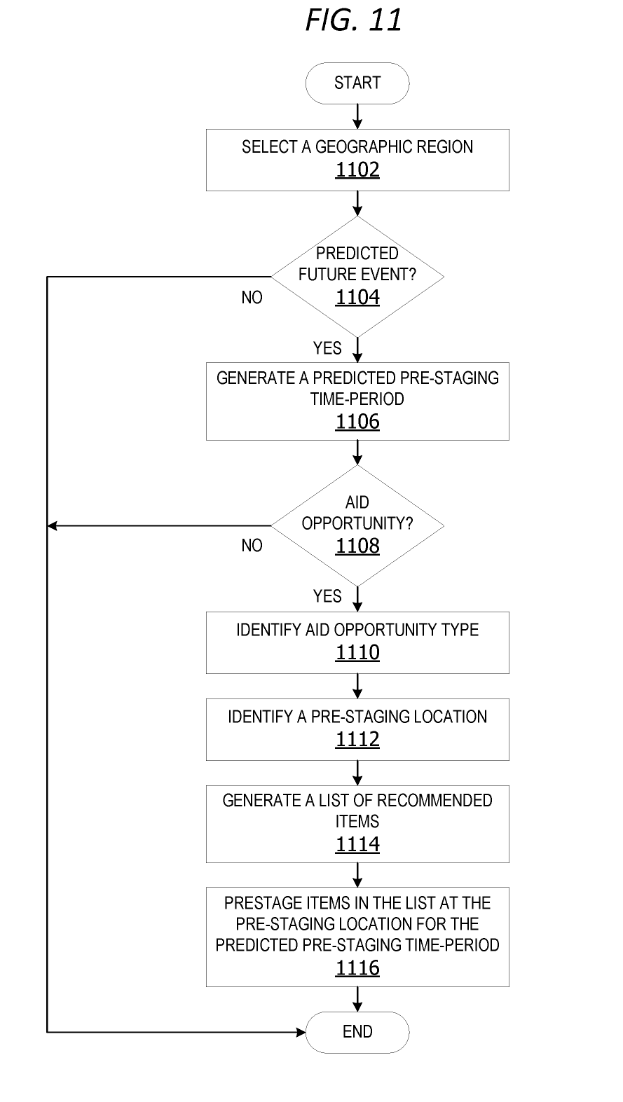

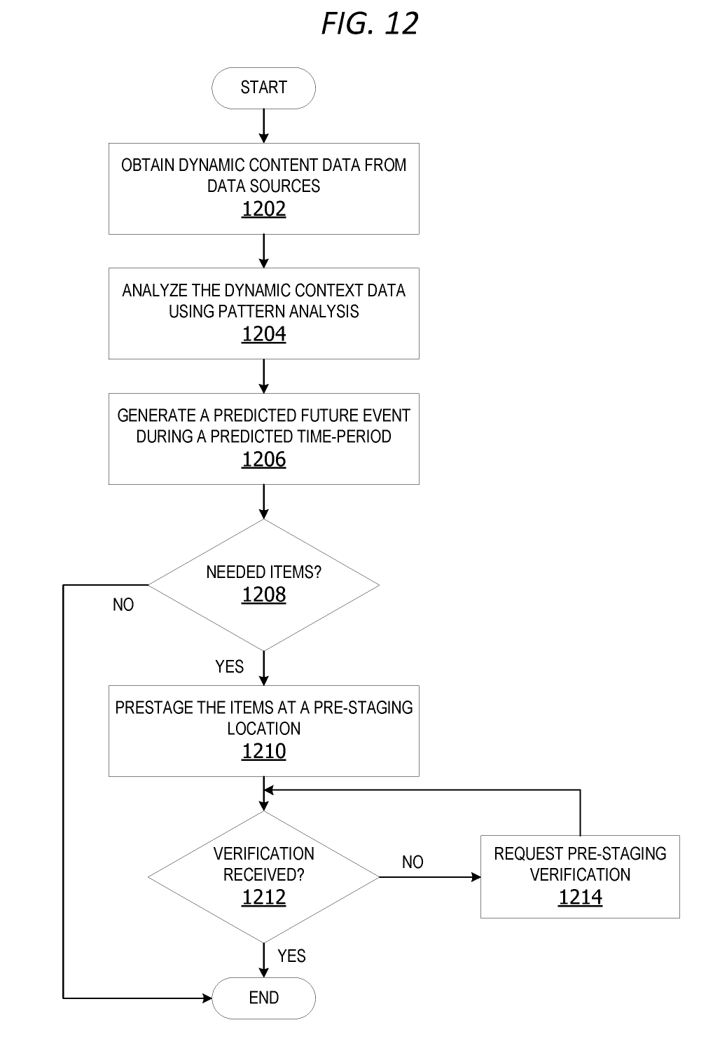

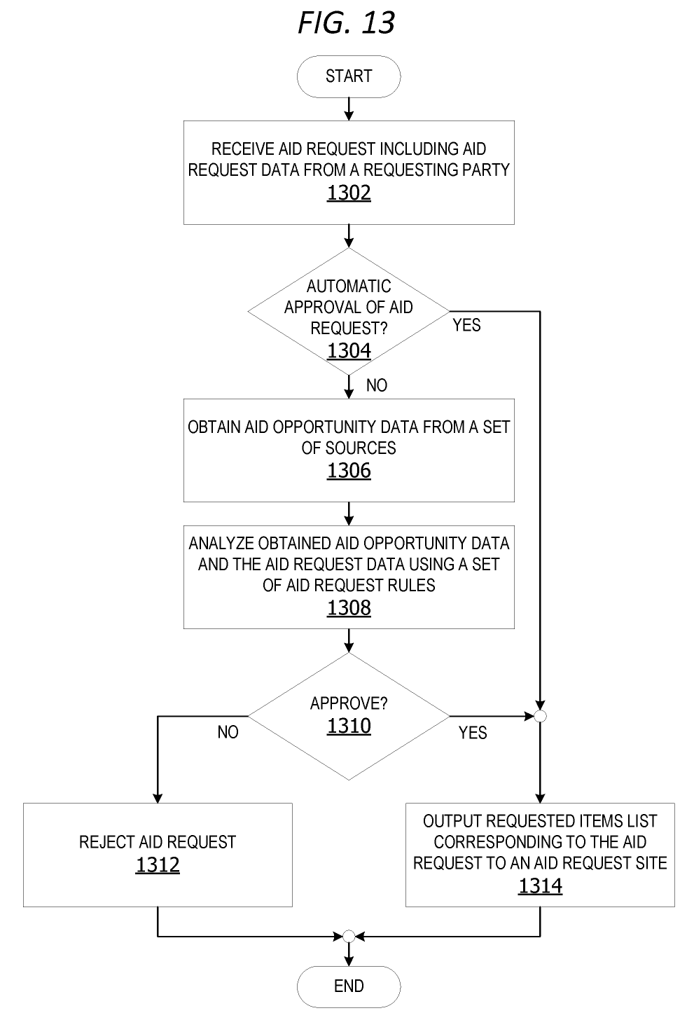

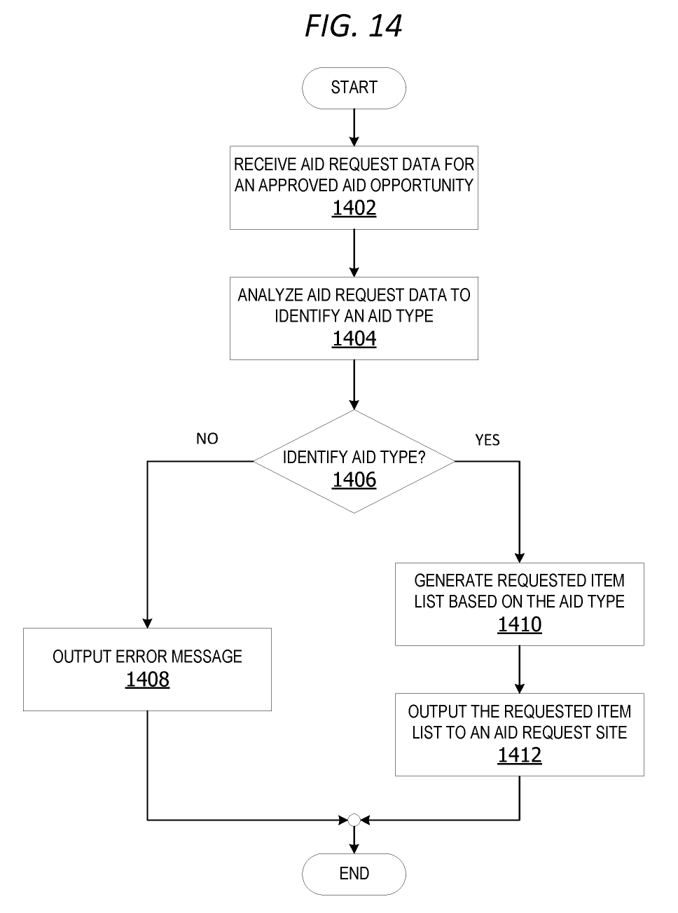

In some examples, the computing device 102 has at least one processor 106, a memory 108, and at least one user interface component 110. The processor 106 includes any quantity of processing units and is programmed to execute the computer-executable instructions 104 for implementing the aid request generator 112 of the examples. The computer-executable instructions 104 may be performed by the processor 106 or by multiple processors within the computing device 102 or performed by a processor external to the computing device 102. In some examples, the processor 106 is programmed to execute instructions such as those illustrated in the figures (e.g., FIG. 9, FIG. 10, FIG. 11, FIG. 12, FIG. 13 and FIG. 14).

The computing device 102 further has one or more computer readable media such as the memory 108. The memory 108 includes any quantity of media associated with or accessible by the computing device 102. The memory 108 may be internal to the computing device (as shown in FIG. 1), external to the computing device (not shown), or both (not shown). In some examples, the memory 108 includes read-only memory and/or memory wired into an analog computing device.

The memory 108 stores data, such as one or more applications. The applications, when executed by the processor, operate to perform functionality on the computing device. The applications may communicate with counterpart applications or services such as web services accessible via a network 114. For example, the applications may represent downloaded client-side applications that correspond to server-side services executing in a cloud.

The network 114 is implemented by one or more physical network components, such as, but without limitation, routers, switches, network interface cards (NICs), and other network devices. The network 114 may be any type of network for enabling communications with remote computing devices, such as, but not limited to, a local area network (LAN), a subnet, a wide area network (WAN), a wireless (Wi-Fi) network, or any other type of network. In this example, the network 114 is a WAN accessible to the public, such as the Internet.

The memory 108 further stores one or more computer-executable components. Exemplary components include an aid request generator 112. The aid request generator 112 in some examples further includes an analysis component 116, a verification component 118, and a notification component 120.

The aid request generator 112, in some examples receives an aid request associated with an aid opportunity from one or more requesting parties. The aid request generator 112 identifies items required to meet the needs associated with the aid opportunity. These requested items are output to users interested in making donations of those requested items to individuals or agencies capable of providing and distributing the requested items to those in need.

An aid request is a request for donations of items for an aid opportunity. The aid opportunity may include a natural disaster, a seasonal event, or an emergency. A natural disaster type of aid opportunity is a weather-related event, such as a flood, tornado, hurricane, earthquake, hail, fire, freezing temperatures, extreme heat, high winds, drought, blizzard, volcano eruption, etc. An aid opportunity may also include disruption of services, infrastructure problems and/or other seasonal events.

A seasonal event type of aid opportunity is an occurrence related to a holiday or other annual/semi-annual occurrence. For example, Christmas is a seasonal event that typically inspires donations of toys to underprivileged children and families, such as the Angel Tree or Toys for Tots. Thanksgiving is another holiday that frequently is accompanied by donations of food to families and homeless shelters. Likewise, the end of summer/beginning of fall (back-to-school) frequently is associated with donations of school supplies, new shoes, and coats to children. Other seasonal events may include winter coat/shoe drives, food bank drives, etc.

Still other aid opportunities may be related to unavailability of utilities or other services, such as electricity, potable water, gas, fuel, etc. An emergency type aid opportunity may include a downed power line or other issue associated with a source of electrical power or fuel resulting in lack of air conditioning in summer or lack of heat in winter. A ruptured water line or drought may result in a lack of clean drinking water. Other emergencies may include fire destroying family homes, flooding damaging roads, or other emergencies.

Aid request data is data provided by the requesting party in an aid request (request for donation of items in response to an emergency event/aid opportunity). Aid request data may identify the charity requesting donations, the location of the charity, the type of items needed, and the reason the items are needed. For example, an animal rescue aid request may include a need for cat-related items related to a recent rescue of many feral cats from an abandoned building. In another example, aid request data may request food, clothes, and household items for flood victims who have been displaced from their homes. Another example aid request may include a request for bottled water and blankets for residents in an area hit by an earthquake or other weather event.

A requesting party is an entity requesting donations of items for an aid opportunity. The requesting party may be an individual, agent, organization, business entity, or other charity requesting donations. In some examples, the requesting party is a non-profit organization or non-governmental organization. For example, a requesting party may be a representative of an animal rescue, a children's foster care group home, an emergency relief group helping victims of natural disasters, or any other type of charity.

The verification component 118 utilizes one or more aid request rules to determine whether to approve or reject the aid request. If an aid request is received from a recognized charity, the verification component 118 approves the request. If the verification component 118 is unable to verify that the aid request is submitted by a legitimate charitable organization or other recognized entity, the verification component 118 rejects the aid request. This ensures that donations and other charitable aid are directed to recognized charities and other accountable entities which will distribute donations to appropriate parties in need.

The verification component 118 in some examples extracts aid request data from the aid request. The aid request data is data identifying the requesting party, the aid request opportunity, location of the aid opportunity, nature of the charitable need, items requested, and/or other data associated with the aid request. The verification component 118 analyzes the extracted aid request data using the aid request rules to determine whether the request is approved or rejected.

In some examples, the aid request rules include a list of pre-approved requesting parties. A pre-approved requesting party is a pre-vetted charitable aid agency, charitable organization, or individual. In some examples, the list of pre-approved requesting parties is a list of recognized 501(c)(3) non-profit organizations.

The list of pre-approved requesting parties is generated by one or more authorized users, such as a manager or administrator. In other examples, the list of pre-approved aid opportunities is provided by a third-party, such as, but not limited to Good360. The third-party verifies one or more charitable organizations and submits the one or more pre-approved requesting parties which are added to the list of pre-approved requesting parties.

A requesting party may be automatically added to the list of pre-approved requesting parties by the aid request generator in some examples if the requesting party is recognized as a charitable organization or charitable agency by an approved third-party source, such as a federal, state, or local government website or other pre-approved third-party source.

The verification component 118 compares login data or other identification data obtained from the aid request with the list or pre-approved requesting parties. If a requesting party submitting a request for items associated with an aid opportunity is included in the list of pre-approved requesting parties, the verification component 118 automatically approves the aid request.

For example, if a request for donations of bottled water is received from a requesting party, such as the AMERICAN RED CROSS™, the verification component 118 checks the list of pre-approved requesting parties. If the requesting party is included in the list of pre-approved requesting parties, the aid request received from the pre-approved requesting party is accepted by the verification component 118.

The aid request rules in other examples include a list of pre-approved aid opportunities. A pre-approved aid opportunity is an aid opportunity pre-approved by an authorized user. The list of pre-approved aid opportunities is created by one or more authorized users, such as a manager or administrator. The list of pre-approved aid opportunities may be provided by a third party.

In some examples, the aid request generator monitors one or more third-party data sources, such as websites, social media, news feeds, etc. If an approved third-party source, such as a news feed or social media site verifies the aid opportunity, the aid request generator automatically adds the aid opportunity to the list of pre-approved aid opportunities. An aid opportunity may be automatically added to the list of pre-approved aid opportunities by the aid request generator if the aid opportunity is acknowledged or authenticated by one or more approved third-party sources.

For example, if a large-scale disaster occurs, such as a hurricane, which necessitates ongoing aid and relief efforts for a given time-period, an authorized user, such as a manager or administrator, may add the aid opportunity to the list of pre-approved aid opportunities. If an aid request is received requesting donations of items for a pre-approved aid opportunity, the verification component automatically approves the aid request in some examples.

The verification component 118 in other examples approves an aid request if the aid request is associated with a pre-approved aid opportunity and the aid request is received from a pre-approved requesting party. The pre-approved list of requesting parties and/or the pre-approved list of aid opportunities enables quick and efficient verification of large-scale charitable needs or widespread/well-known disasters. The pre-approved list of requesting parties and/or the pre-approved list of aid opportunities further enables fast and efficient approval of well-known or established charitable organizations.

If the aid request is not pre-approved using the list of pre-approved requesting parties and/or the list of pre-approved aid opportunities, the verification component performs an analysis on the aid request to determine whether to approve or reject the request.

If an aid request is not pre-approved, the verification component 118 mines a set of one or more sources 132 to obtain aid opportunity data. The verification component 118 analyzes the aid opportunity data to determine whether the requesting party is a legitimate charity, whether the aid request is associated with a verified aid opportunity and/or whether the aid opportunity is associated with an event that occurred. The verification component 118 analyzes the aid request data using the aid request rules to determine whether to approve or reject the request.

In some examples, the aid request rules specify that an aid request is rejected if the aid opportunity is not verified by two or more independent sources. For example, if an aid request associated with a local apartment fire is received from a local shelter, the verification component 118 checks the requesting party and the aid opportunity apartment fire against the lists of pre-approved requesting parties and/or pre-approved aid opportunities. If the request is not pre-approved, the verification component 118 extracts aid request data from the aid request detailing the location of the fire, date of the fire, and other information. The verification component 118 compares the aid request data against data retrieved from the set of sources 132. If data retrieved from two or more different sources in the set of sources confirms the apartment fire, the aid request is approved. In this example, if two different news sources confirm the apartment fire, the request is approved. However, if the apartment fire cannot be verified by the two or more independent sources, the aid request is rejected.

In other non-limiting examples, one or more aid request rules may specify that an aid request is approved if the aid opportunity is verified by at least one news source and at least one social media source. In still other examples, the aid request rules include a rule for approving an aid request if the aid opportunity is verified by a weather-related website. In other examples, an aid request may be approved if the aid opportunity is confirmed by at least one federal, state, or local government website.

The set of sources 132 includes sources of data associated with an aid opportunity. A source in the set of sources 132 may include a data feed. A data feed may be a news feed, a social media feed, or any other type of data feed. Another source may include user input provided by one or more authorized users. The set of sources 132 may also include a database of historical aid opportunity data.

If the aid request is rejected, the verification component 118 sends a notification to the requesting party that the request is rejected. Unverified or unconfirmed aid requests are rejected to prevent fraudulent requests for item donations.

If the aid request is approved, the analysis component 116 analyzes historical data, including information associated with the types of items needed for various past aid opportunities and aid types, to generate the requested items list.

In some examples, the aid type of a current aid opportunity is matched to items needed for other aid opportunities having the same aid type. This information is utilized to predict what items and how many of each type of item is needed. The aid request generator 112 utilizes this information to identify at least one requested item 122 needed for the current aid opportunity.

The analysis component 116 may utilize static data and dynamic data to generate a requested items list for a given approved aid opportunity. Static data includes previous aid opportunity data, such as historical aid opportunity data associated with previous aid opportunities, past donations, previous requested items lists, items donated to the past (historical) aid opportunities, items used for the previous aid opportunities, and/or surplus items donated but not actually used in the previous (historical) aid opportunities. Dynamic data includes current contextual data, such as current weather, future weather forecasts, news, temperature, etc.

The analysis component 116 in other examples includes a machine learning 140 component for analyzing the static data and dynamic data to generate requested items lists. The machine learning 140 includes algorithms for analyzing data and generating data-driven predictions based on prediction modeling and pattern recognition (pattern analysis).

The machine learning 140 utilizes the analysis results as feedback to anticipate future aid opportunity needs. In some examples, every new aid opportunity received by the aid request generator is fed back into the machine learning 140. This feedback is analyzed to adapt, refine, and improve generation of requested items lists for approved aid opportunities.

The previous aid opportunity data may be gathered based on user input and database information indicating items requested, items donated, and items used. The previous item data may also include user feedback indicating surplus items which were not used as well as additional items that were not requested or supplied but were needed. In other words, if the requesting party did not request enough items to meet needs, the deficit data is used by the machine learning 140 to improve predictions of future needed items. Likewise, if there is a surplus of items because too many of one type of item is requested, the machine learning 140 utilizes the surplus items data as feedback to improve the accuracy of future requested items lists.

In still other examples, the previous aid data may also include radio frequency identification (RFID) data associated with items provided to a receiving party for one or more previous aid opportunities, as well as current aid opportunities. The RFID tracking enables more efficient machine learning and improved accuracy of predictions for future aid opportunity requirements.

In one example, if a requested items list for an aid opportunity includes four-hundred packages of paper, which are donated by users, but the receiving party only utilizes one-hundred packages of the paper. In this example, the other donated three-hundred packages of paper remain in storage, such as a warehouse. The data regarding how many items are used and how many remain unused in storage may be obtained from RFID tag data or shipping/receiving invoices. The machine learning 140 receives the information regarding the number of items used and the number of unused items as feedback. This feedback is analyzed by the machine learning 140 to improve generation of future requested items lists for the same or similar aid opportunities.

In other examples, if three-hundred packages of flashlight batteries are donated to a requesting party for an aid opportunity, but only two-hundred packages of flashlight batteries are picked up and utilized while the other one-hundred packages remain in storage, the aid request generator 112 maintains a record of the number of unused items for the given requesting party remaining in storage.

In some examples, if a next aid opportunity arises, the aid request generator 112 takes the additional one-hundred unused packages of flashlight batteries into account when calculating the number of items and types of items needed for the new aid opportunity. In other words, if the aid request generator 112 determines that two-hundred flashlights and two-hundred packages of flashlight batteries will be needed for the new aid opportunity, the aid request generator reduces the number of requested packages of flashlight batteries by one-hundred to adjust for the unused one-hundred packages of flashlight batteries remaining in storage for the requesting party. This enables the aid request generator 112 to make more accurate predictions of needed items for increased efficiency in utilization of donation dollars. Moreover, the feedback data further enables the analysis component 116 to more accurately and efficiently predict which type of items and how many of each type of items will likely be required and utilized for a disaster or other aid opportunity while reducing surplus donations and other waste.

In other examples, the analysis component 116 utilizes base training data regarding what emergency personnel have provided to victims of disasters and other events in the past. This static history data is utilized by the machine learning 140 to predict items that may be needed for current and future disaster events.

In some examples, the machine learning 140 is trained using history data (previous/historical aid opportunity data), including information associated with a plurality of disaster types, a plurality of need types, a plurality of aid types, emergency personnel data, a plurality of product types, environmental condition data, geographic location data, and demographic location data.

The set of sources 132 may be sources associated with one or more computing devices, such as the set of client devices 134. The set of client devices 134 in this example includes one or more client devices. The set of sources 132 may also be sources associated with a data storage device, a database, a filesystem, or other data source.

For example, an aid request rule may state that an aid request is only valid/verified if it originated from a registered 501(c)(3) organization. In this example, the verification component 118 checks aid request data and a registry of registered 501(c)(3) organization to determine whether to approve the aid request. In other examples, an aid request rule may require aid requests include contact information for the requesting party. If the contact information is omitted from the request, the aid request is rejected by the verification component 118.

In still other examples, the aid request generator 112 does not generator or output a requested items list for an aid request unless the aid opportunity associated with the aid request is approved. If the aid opportunity is approved, analyzes the received aid request data and/or aid opportunity data associated with the aid opportunity to identify an aid type 138. The aid type is a type or classification for an aid opportunity. For example, an aid opportunity may be an aid type 138 associated with flood relief. Another aid type 138 may be associated with Christmas-related toy donation requests. Each aid type 138 is associated with different types of recommended items. For example, the aid opportunity for flood victims may include recommended items such as bottled water, blankets, non-perishable food, temporary shelters, medical supplies, etc. The aid opportunity related to children's Christmas events may include unwrapped toys, new children's shoes, new children's clothing, gift cards, wrapping paper, gift bags, etc. In other words, the types of items likely to be requested for different aid types may vary considerably. The system utilizes the aid type to pre-stage appropriate items based on the predicted type of aid opportunity.

The analysis component generates a recommended items list based on the identified aid type 138. The recommended items list includes at least one requested item 122. A requested item is an item likely to be requested if the event associated with the aid opportunity occurs or if the aid opportunity is approved/verified. In some examples, the aid request generator assigns an expiration date to the at least one requested item 122. On occurrence of the expiration date, the at least one requested item 122 is removed from the requested items list or the requested items list is removed from the aid request site 124.

The user interface component 110 in some examples is implemented on the at least one processor 106 to output the generated requested items list to an aid request site. If an expiration date is assigned to the generated requested items list, the requested items list is only made available on the aid request site until the expiration date. On an occurrence of the expiration date, the requested items list is removed from the aid request site.

In some examples, the user interface component includes a graphics card for displaying data to the user and receiving data from the user. The user interface component may also include computer-executable instructions (e.g., a driver) for operating the graphics card. Further, the user interface component may include a display (e.g., a touch screen display or natural user interface) and/or computer-executable instructions (e.g., a driver) for operating the display. The user interface component may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device in a specific manner.

The aid request site 124 is an online retail site or other webpage providing user access to the requested items list and enabling users to purchase and donate items identified in the requested items list. The aid request site 124 is hosted on a server 126. The server 126 may be implemented as any type of computing device for hosting a webpage or website accessible via the network 114, such as, but without limitation, a web server, application server, cloud server, or other host.

In this example, the aid request generator 112 runs on the computing device 102 and the aid request site 124 runs on the server 126. In other examples, the aid request site 124 and the aid request generator 112 may be located on the computing device 102. In still other examples, the aid request site 124 and the aid request generator 112 may be located on the server 126. For example, both the aid request site 124 and the aid request generator 112 may be executed on a cloud server.

The aid request site in some examples includes inventory corresponding to the output requested items list. In other words, the aid request site is associated with a provider having access to an inventory of items including the items in the requested items list.

In some examples, the output requested items list is accessible to users of the aid request site 124 for direct purchase of selected items. For example, the user 136 may access the aid request site 124 via a client device 128 associated with the user 136.

The client device 128 associated with a user 136 represents any device executing instructions (e.g., as application programs, operating system functionality, or both) to implement the operations and functionality associated with the computing device. The client device 128 may include a mobile computing device or any other portable device. In some examples, the mobile computing device includes a mobile telephone, laptop, tablet, computing pad, netbook, gaming device, and/or portable media player. The client device 128 may also include less portable devices such as desktop personal computers, kiosks, tabletop devices, industrial control devices, wireless charging stations, and electric automobile charging stations. Additionally, the client device 128 may represent a group of processing units or other computing devices.

The user 136 utilizes a user interface, such as a web browser, to access the output requested items list. The user may select and purchase one or more items from the list for donation of the selected items to the aid opportunity via the aid request site 124.

The aid request site 124 in some examples includes an item table providing a list of the requested items needed for the aid opportunity. A user utilizes a user interface associated with a client device to select one or more items from the item table to purchase for donation to the chartable aid opportunity.

The aid request site 124 in other examples includes a county and store location table. The user utilizes the country and store location table to select a country, state, city, or other area associated with an aid opportunity/donation location. The user selects a county or other location in which the user wants to donate items. For example, a user may choose to donate items to flood victims in Florida or the user may choose to donate needed items to children in South America.

The aid request site 124 provides updates or notifications to the aid request generator 112 indicating when one or more items on the requested items list is selected and donated by a user, such as user 136. The aid request generator 112 updates the requested items list to reflect items which have been donated by users and therefore are no longer needed because they have already been provided by one or more donors.

In yet other examples, the notification component 120 is executed to generate a notification to the requesting party indicating which items in the requested items list have been selected and donated to the aid opportunity by users of the aid request site.

In other examples, the notification component 120 generates notifications including an identification of both the selected items and un-selected. The un-selected items are the items in the requested items list that remain un-donated after a per-aid opportunity time-period. In some examples, a notification of un-donated items is sent to the requesting party at the end of the per-aid opportunity time-period. In other examples, a list of un-donated items remaining at expiration of the per-aid opportunity time-period are provided to corporations, churches, local businesses, regional businesses, or other organizations to request assistance in obtaining the un-donated items for the requesting party.

The per-aid opportunity time-period is a time span during which users may purchase items from a list of requested items for donation to a given aid opportunity. The per-aid opportunity time-period may be a user-selected time-period or a default time-period based on the type of aid opportunity. For example, the per-aid opportunity time-period may last three-weeks for tornados and six-weeks for hurricanes.

The per-aid opportunity time-period for a fire may be a default per-aid opportunity time-period of one week, for example. During the one week per-aid opportunity time-period donations of items for victims of the fire are accepted. After the one-week time-period, donations are no longer requested from users.

In another example, the per-aid opportunity time-period for a tornado-related aid opportunity may be set for a one-month time-period. Lists of requested items for charitable organizations assisting victims of the hurricane can request and receive donations during the one-month time-period. The lists of requested items are removed from view by users when the one-month time-period expires. In other words, donations are only requested for the tornado victims during the per-aid opportunity time-period.

The per-aid opportunity time-period may be selected by the requesting party, an administrator, or other user. In some examples, a list of requested items for donations of toys for children at Christmas may be a time-period that expires on a given date. For example, all aid opportunities associated with obtaining toys for children at Christmas may have a per-aid opportunity time-period that ends on December 20^{th}, to ensure adequate time for toy pick-up and delivery to appropriate recipients prior to Christmas day. The per-aid opportunity time-period may last a month for one requesting party and only last five days for another requesting party.

In other words, the un-selected items have not yet been obtained for the aid opportunity. The notification to the requesting party in other examples includes an expiration date. When the expiration date is reached, the requested items list is removed from the aid request site regardless of any unfilled/un-selected items remaining on the list.

In still other examples, the notification generator generates and outputs a notification to a receiving party identifying selected items ready for pickup by the receiving party. The receiving party is an entity authorized to accept the donated selected items on behalf of the requesting party.

The computing device 102 optionally includes a communications interface component 130. In some examples, the communications interface component includes a network interface card and/or computer-executable instructions (e.g., a driver) for operating the network interface card. Communication between the computing device and other devices may occur using any protocol or mechanism over any wired or wireless connection. In some examples, the communications interface is operable with short range communication technologies such as by using near-field communication (NFC) tags.

In other examples, the system 100 includes a set of one or more sensor devices 142 located within a pre-staging location 138. The pre-staging location 138 is a location or area where one or more items 140 from the list of recommended items is pre-staged prior to occurrence of a predicted event associated with an aid opportunity. The set of sensor devices 142 generate sensor data associated with the items 140. The set of sensor devices 142 in some examples transmits the sensor data to the aid request generator 112 via the network 114. The aid request generator 112 analyzes the sensor data to determine the inventory of items stored at the pre-staging location 138.

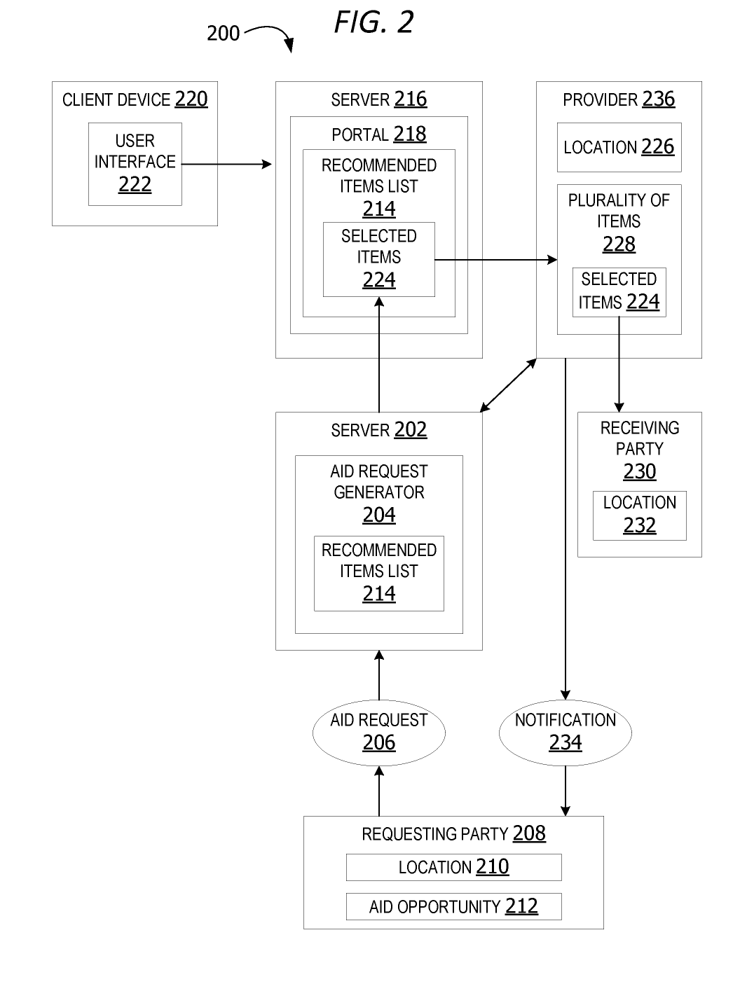

FIG. 2 is an exemplary block diagram illustrating a server for generating requests for needed items associated with an aid opportunity. The system 200 includes a server 202 for hosting an aid request generator 204, such as the aid request generator 112 in FIG. 1. The aid request generator 204 receives an aid request 206 from a requesting party 208 associated with a location 210. The aid request 206 is a request for donated items corresponding to an aid opportunity 212. The aid opportunity is an event, cause, or other situation giving rise to a need for an aid opportunity, such as, but not limited to, a natural disaster.

In some examples, a pre-vetted requesting party may log into the portal 218 to enter an aid request associated with a disaster, need or other aid opportunity. The aid request generator 204 in these examples confirms the requesting party is pre-approved based on a list of pre-approved requesting parties and/or a list of pre-approved aid opportunities. If the requesting party and/or the aid opportunity is pre-approved, the aid request generator 204 approves the aid request from the requesting party.

In other examples, the aid request generator 204 analyzes aid request data extracted from the aid request to determine whether to accept or reject the aid request received from a requesting party that is not pre-approved. If the aid request generator accepts the aid request, the aid request generator 204 identifies aid request data from the aid request 206. The aid request generator 204 utilizes the aid request data to generate recommended items list 214. The recommended items list 214 includes one or more items needed for the aid opportunity 212.

In some examples, the recommended items list 214 is generated by the aid request generator 204. The requested items list may be provided in part by the requesting party 208 and created in part by the aid request generator 204. In still other examples, the requesting party 208 provides the recommended items list 214 to the aid request generator 204.

If the aid request is approved, the aid request generator 204 sends the recommended items list 214 to a server 216. The server 216 is any type of computing device for hosting an aid request site, such as the server 126 in FIG. 1. The server 216 in this example provides a portal 218 corresponding to the aid opportunity 212. A user may log into the portal 218 to access the requested items list. A requesting party may log into the portal 218 to request a list of needed items (requested items list) be posted on the aid request site.

The user interface 222 of a client device 220 provides a user associated with the client device 220 with access to the aid request site. The user interface 222 further provides access to the recommended items list 214. The user associated with the client device 220 may optionally select one or more items from the requested items list for purchase. The user interface 222 in other examples also provides real-time information to the user about the donated selected items.

The aid request generator 204 in some examples analyzes existing inventory associated with one or more providers of one or more selected items 224. A provider 236 of at least one selected item is a distribution center, retail store, warehouse, collecting store, or other location storing or otherwise providing the at least one selected item to a recipient of the item. The aid request generator 204 analyzes the inventories of providers within a predetermined distance from the receiving party 230 to identify one or more providers of the requested items 224.

The server 216 in some examples sends a notification to an identified provider 236 of the one or more selected items 224. The provider 236 is a store, distribution center, warehouse, or other location 226 having a plurality of items 228. The plurality of items 228 available to the provider 236 includes the selected items 224 purchased by a user associated with the client device 220 for donation to a charity associated with the aid opportunity 212.

In some examples, the provider 236 is chosen from a plurality of providers based on the location 226 of the provider. The provider 236 in these examples is a provider located near or in proximity to the location of the aid opportunity. For example, if the aid opportunity is a fire in California which has destroyed many residences, the aid request generator 204 chooses a provider 236 located in California near the area where the fire occurred, such as in proximity to the homes damaged by the fire.

In other examples, the one or more selected items are shipped from one or more providers to a location within the predetermined distance from the receiving party 230 for pickup by the receiving party. In these examples, the requested items are shipped from one or more different providers to a single location for pickup by the receiving party. The provider or pickup location may be a distribution center, retail store, collecting store, or any other pickup location.

The provider 236 releases donated selected items 224 to the receiving party 230 associated with the requesting party 208 in some examples. The receiving party 230 is an entity accepting delivery or taking possession of the donated selected items on behalf of a requesting party 208. The receiving party may be a charitable organization, such as the American Red Cross™ or other charitable organization. The receiving party 230 in this example is located within proximity to the aid opportunity.

In this example, the receiving party 230 is a different party than the requesting party 208. The location 232 of the receiving party 230 is a different geographic location than the location 210 of the requesting party 208, in this example. However, in other examples, the requesting party 208 may be the same as the receiving party 230. In other examples, the selected items 224 may be released to the requesting party 208 rather than to a different receiving party.

The provider 236 in some examples sends a notification 234 to the requesting party 208 and/or the aid request generator 204 indicating that the receiving party 230 has taken possession of the selected items. In other examples, the provider 236 provides notice to the server 216 that the receiving party has received possession of the selected items 224. The server 216 then forwards the notification 234 to the aid request generator 204 at the server 202. The aid request generator 204 then sends a notification to the requesting party 208 indicating that the receiving party picked-up the donated selected items 224.

In some examples, the provider 236 sends a notification indicating one or more donated selected items are ready for pick-up to the receiving party 230. In still other examples, the provider 236 sends the notification 234 indicating the donated selected items are ready for pick-up to the requesting party and/or to the aid request generator 204. The requesting party 208 then notifies the receiving party 230 to pick-up the donated selected items 224.

In this example, the aid request generator selects the provider based on the location of the provider, the inventory of items available from the provider, and the location of the aid opportunity. In other examples, the aid request generator selects the provider based on the location of the provider, the inventory of items available from the provider, and the location of the receiving party. The aid request generator may determine the location of the providers, aid opportunities, inventories, and/or receiving parties based on an analysis of the aid request data and the aid opportunity data retrieved from the set of sources.

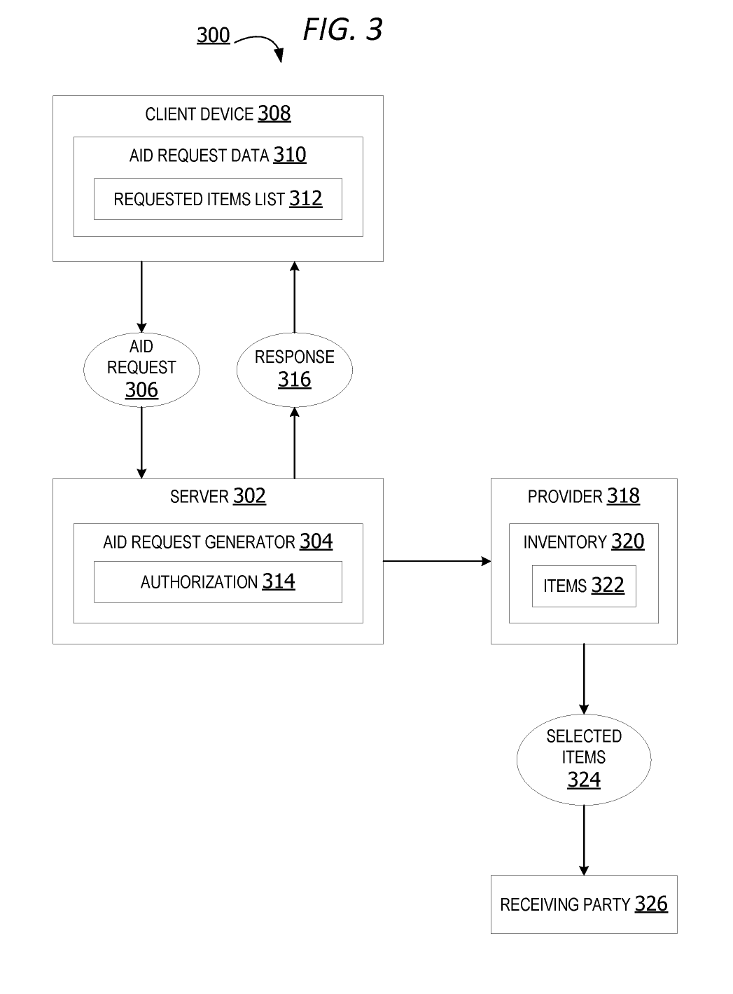

FIG. 3 is an exemplary block diagram illustrating a server for receiving a request for needed items associated with an aid opportunity. The system 300 includes a server 302. The server 302 is a computing device, such as the computing device 102 in FIG. 1 and/or the server 202 in FIG. 2. The aid request generator 304 receives an aid request 306 corresponding to an aid opportunity. In this example, the aid request 306 includes aid request data 310. The aid request data 310 in this example includes pre-generated requested items list 312. The requested items list 312 is a list of one or more items requested by a requesting party, such as a charity or other party responding to an emergency/aid opportunity.

The requesting party in this example provides a requested items list in the aid request 306 provided to the aid request generator 304. In other examples, the aid request generator 304 generates the requested items list based on the aid type of the aid opportunity and other aid opportunity data.

The aid request generator 304 performs an authorization 314 of the aid request 306. In some examples, the authorization is performed by a verification component, such as the verification component 118 in FIG. 1. The verification component compares aid request data with a list of pre-approved requesting parties and/or a list of pre-approved aid opportunities to determine whether to automatically authorize and approve an aid request. If the aid request is not automatically approved, the verification component analyzes the aid request data using aid request rules and data obtained by monitoring one or more third-party data sources. If an approved third-party data source monitored by the verification component validates the occurrence or existence of the aid opportunity, the aid opportunity is approved. In some examples, the aid request generator updates the list of pre-approved aid opportunities in response to verifying an occurrence or existence of the aid opportunity via the one or more approved third-party data sources, such as a news feed, social media source, or other approved third-party data source.

If the aid request is not approved, the aid request is rejected. A response 316 is returned to the client device 308 associated with the requesting party. The response 316 in some examples includes a notification that the aid request is rejected. The requesting party may optionally submit a new aid request via the client device 308.

If the aid request 306 is approved by the aid request generator 304, the aid request generator 304 posts the requested items list 312 provided by the requesting party to an aid request site via a network connection between the server 302 and the client device 308. When one or more items are selected by users for donation to the aid opportunity, the aid request generator 304 sends a notification to the provider 318. The provider 318 is a distribution center, store, or other entity having an inventory 320 of one or more items 322 including the items on the requested items list 312.

The provider 318 receives the notification of the selected items 324 and/or an identification of the receiving party from the aid request generator 304. The provider 318 releases the selected items 324 to a receiving party 326. The receiving party 326 is a party receiving or picking up the selected items 324.

In this example, the server 302 hosts both the aid request generator 304 and the aid request site. In other examples, the server 302 hosts the aid request generator and another separate server hosts the aid request site.

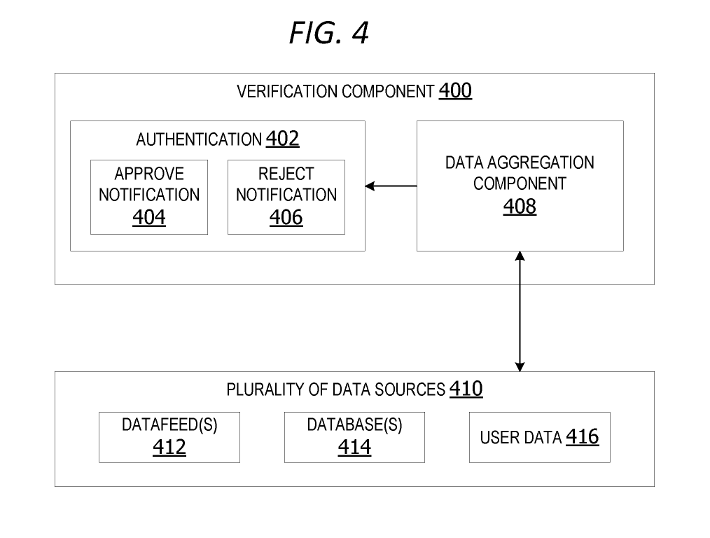

FIG. 4 is an exemplary block diagram illustrating a verification component for authenticating an aid opportunity. The verification component 400 is a component that performs authentication 402 of a received aid request, such as the verification component 118 in FIG. 1. In some examples, the verification component 400 analyzes aid request data and/or aid opportunity data to authenticate the aid request. If the aid request is authenticated, the verification component approves the aid request. If the verification component fails to authenticate the aid request, the verification component rejects the aid request.

If the aid request is approved, the verification component 400 generates an approve notification 404 to the aid request generator indicating the requested items list for the aid request should be generated and/or sent to the aid request site. In other words, the approve notification 404 grants approval to the request. If the aid request is rejected, the verification component generates a reject notification 406 indicating that a list of requested items should not be generated or made available on the aid request site.

The verification component 400 determines whether an aid request is a pre-approved request and/or a pre-approved aid opportunity. If the request or corresponding aid opportunity is pre-approved, the aid request is authenticated and approved. If not, a data aggregation component 408 of the verification component 400 obtains aid opportunity data from a plurality of sources 410.

The plurality of sources 410 includes one or more data feeds 412, one or more databases 414, user data 416 provided by a user via a user interface or input device, as well as any other sources of data associated with an aid opportunity. A data feed may include a news data feed, a weather data feed, social media data feed, emergency alert data feed, or any other data feed. The verification component 400 analyzes the aggregated aid opportunity data to verify that the aid request is associated with an approved aid opportunity.

For example, if an aid request asks for donations of household items for victims of a fire, the verification component 400 checks data from news feeds and other sources to verify whether a fire took place at the location and/or data specified in the aid request data.

The verification component in this example analyzes data from sources such as, but not limited to, news data, charitable organization registrations, business entity records/secretary of state records, tax exempt status, etc.

In other examples, the verification component 400 may require human input for verification of an aid request. In this example, the verification component 400 prompts a client device associated with an authorized user to approve a given requesting party and/or approve a given aid request.

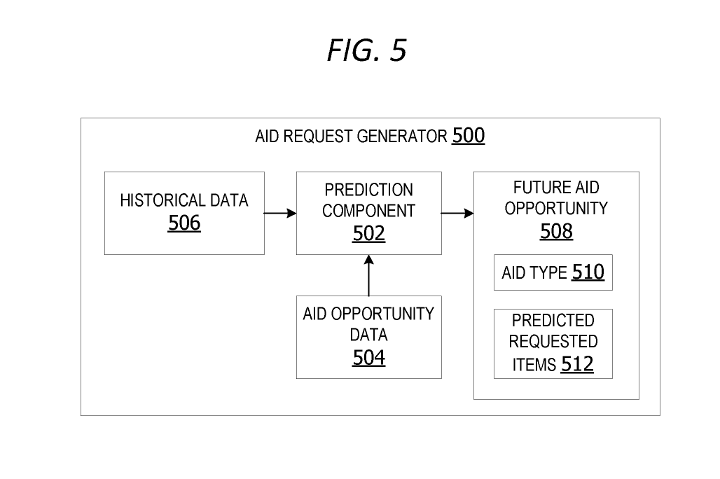

FIG. 5 is an exemplary block diagram illustrating an aid request generator for predicting future aid opportunities. The aid request generator 500 in this example includes a prediction component 502. The prediction component 502 utilizes current aid opportunity data and/or historical data 506 associated with past aid opportunities, such as news feeds, event data, user input, and other data, to predict a future aid opportunity 508 having a future aid type 510 and predicted requested items 512.

The future aid opportunity 508 is an event that has not yet occurred. For example, if hurricanes frequently strike the coast during the summer months, a future aid opportunity may include a predicted hurricane along coastal areas during the summer months. The predicted requested items 512 may include plywood, bottled water, batteries, flashlights, and sandbags. The predicted requested items 512 are not yet needed. However, these items may be made available in inventory in anticipation of the possible hurricane event.

Likewise, a predicted future aid opportunity created in June may be an aid opportunity for underprivileged children requiring school supplies in August/September when the new school year begins. The predicted requested items 512 may include various school supplies, back packs, and lunch boxes. This permits planning and acquisition of required items in anticipation of the future need/event that will happen in the future rather than acquiring items for a current need or event that has already occurred in the past.

The aid request generator 500 in other examples analyzes aid opportunity data 504 and the historical data 506 to determine if the requesting party is affiliated with a legitimate, recognized charitable organization. The historical data 506 is data associated with previous aid opportunities, items needed for those previous aid opportunities, etc.

In some examples, the aid request generator outputs the generated future aid requested items list to a provider for inventory preparation in anticipation of the event. The provider obtains the items on the future aid requested items list in preparation for the predicted event. In other words, the future aid requested items list enables a user to obtain items which may be need in the event the predicted aid opportunity occurs.

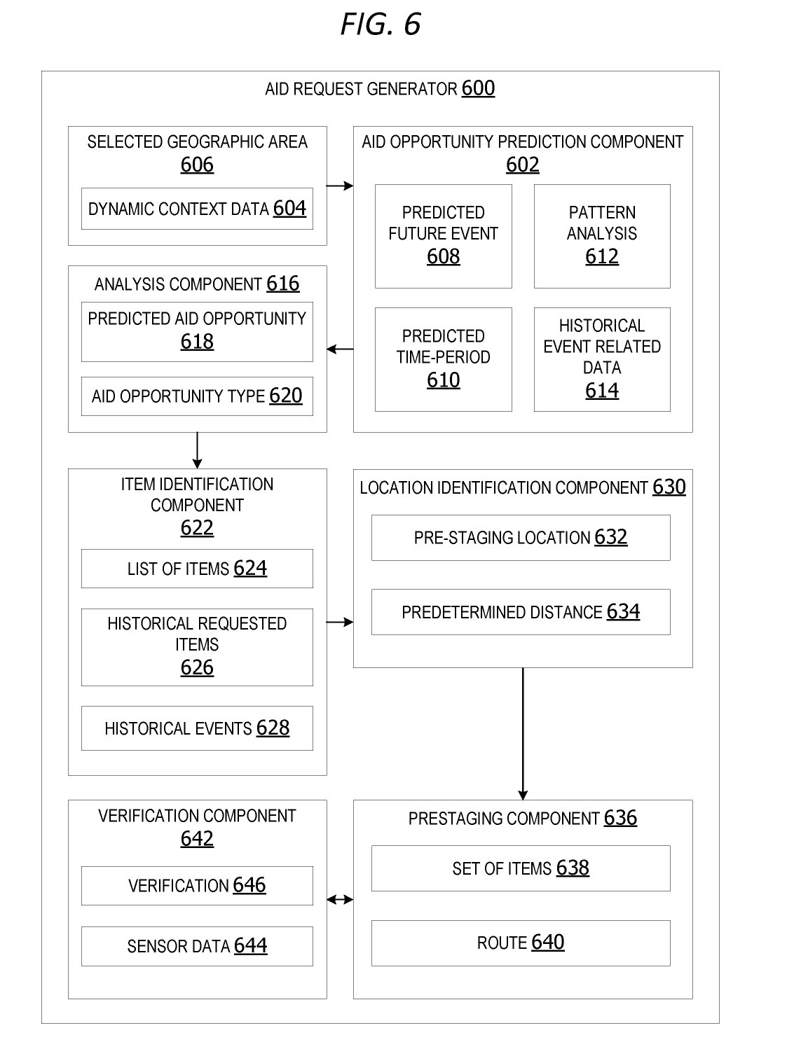

FIG. 6 is an exemplary block diagram illustrating an aid request generator 600 for pre-staging recommended items for predicted aid opportunities. An aid opportunity prediction component 602 receives dynamic context data 604 associated with a selected geographic area 606 from one or more data sources, such as, but not limited to, the plurality of data sources 410 in FIG. 4. The dynamic context data 604 is data associated with real-time conditions of the selected geographic area 606. The dynamic context data 604 may include current weather, historical weather, time, date, season, local events, holidays, sporting events, news, etc. The weather data may include temperature, humidity, volcanic activity, seismic activity, rain fall, ground saturation level, snow fall accumulation, etc.

The aid opportunity prediction component 602 generates a predicted future event 608 within the selected geographic area 606 and a predicted time-period 610 for pre-staging items prior to an occurrence of the predicted future event 608. The predicted future event 608 is generated based on an analysis of the dynamic context data 604 using pattern analysis 612 and historical event-related data 614 associated with the selected geographic area 606.

An analysis component 616 identifies a predicted aid opportunity 618 associated with the predicted future event 608. An aid opportunity is an effort or organized activity to meet a need associated with the predicted future event 608 or an event that has already occurred. The aid opportunity may include, without limitation, a charitable cause or response to an emergency event. The analysis component 616 identifies an aid opportunity type 620 of the predicted aid opportunity 618. The aid opportunity type 620 is a type or classification associated with the aid opportunity, such as, but not limited to, the aid type 510 in FIG. 5.

An item identification component 622 generates a list of items 624 predicted to be requested on condition the predicted future event 608 transpires within the predicted time-period 610 based on historical requested items 626 associated with historical events 628 of the predicted aid opportunity type 620. A location identification component 630 identifies a pre-staging location 632 within a predetermined distance 634 from the selected geographic area. The predetermined distance 634 may be a threshold distance, a threshold distance range, a configurable distance or a pre-defined value. The pre-staging location 632 in this example is located within a convenient transportation distance or threshold range from the location at which the predicted future event is expected to occur.

In one example, if heavy rains are expected to result in localized flooding in a specific region of a city, such as a flood plain, the pre-staging location 632 is located far enough away to ensure the storage area is outside the flood plain but near enough to enable quick access and efficient distribution of flood relief supplies pre-staged within the pre-staging location 632. Thus, the predetermined distance 634 in this non-limiting example is the distance at which the pre-staged items may be quickly and efficiently distributed while preventing the items from being damaged during the predicted event, such as the flooding.

A pre-staging component 636 determines a route 640 for transport of a set of items 638 identified in the list of items 624 to a storage area associated with the identified pre-staging location 632. The pre-staging location 632 may be a distribution center, a warehouse, an item pick-up kiosk, an item-pickup locker, a store, a backroom area of a store, or any other type of area at which items may be stored.

The set of items 638 may include any type of items which would be useful or requested during the predicted future event. The set of items may include, without limitation, food, water, clothing, blankets, diapers, towels, coats, masks, gloves, cots, or any other items which may be suitable based on the aid opportunity type 620 associated with the event.

In some examples, the set of items 624 are stored at the pre-staging location 632 for the predicted time-period during which the event is expected to occur. If the event fails to occur prior to expiration of the predicted time-period 610, the items may be re-distributed to other distribution centers, warehouses, or other areas.

In some examples, a verification component 642 verifies presence of the set of items 624 within the storage area at the identified pre-staging location 632 at one or more times during the predicted time-period. The verification component 642 in this examples receives sensor data from 644 from one or more sensor devices at the pre-staging location. The sensor devices may include RFID tag readers, cameras, barcode scanners, or any other type of sensor device. The verification component performs the verification 644 based on results of analysis of the sensor data obtained to determine which items in the list of items are physically present/stored at the pre-staging location for distribution if the predicted future event 608 occurs.

In other words, if the aid request generator 600 determines a predetermined number of pallets of water bottles should be pre-staged near a small town in tornado alley prior to occurrence of a predicted/potential tornado during tornado season, the verification component 642 analyzes sensor data to determine how many pallets of water bottles have been pre-staged. The verification component 642 may determine if the recommended number of pallets have been pre-staged. If not, the system may route additional pallets of water to the pre-staging area/location until the recommended number of pallets are on-hand prior to occurrence of the predicted tornado. Thus, if the tornado does touch down in the town, water bottles, flash lights and other supplies are already pre-staged nearby and ready for faster and more efficient distribution to those in need.

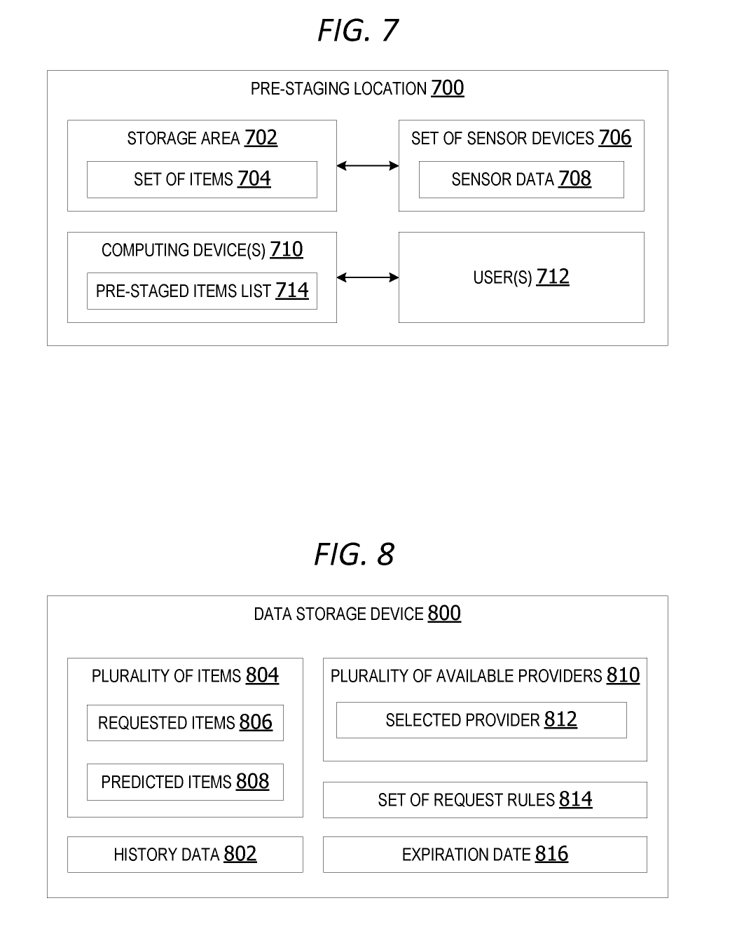

FIG. 7 is an exemplary block diagram illustrating a pre-staging location 700 associated with a predicted aid opportunity. The pre-staging location 700 includes at least one storage area 702 for storing a set of one or more items requested or recommended for an aid opportunity.

A set of sensor devices 706 associated with the pre-staging location 700 generates sensor data 708 associated with the set of items 704 stored in the storage area 702. The sensor data is analyzed to generate a pre-staged items list 714. The pre-staged items list is a list of each item in the set of items 704 pre-staged/stored within the pre-staging location 700. In some non-limiting example, a computing device 710 may be utilized to analyze the sensor data to generate the pre-staged items list. The user 712 monitors the pre-staged items lists 714.

FIG. 8 is an exemplary block diagram illustrating a data storage device storing data associated with one or more aid opportunities. The data storage device 800 is a set of one or more data storage devices for storing data. The data storage device 800 may include one or more types of data storage devices, such as, for example, one or more rotating disks drives, one or more solid state drives (SSDs), and/or any other type of data storage device.

The data storage device 800, in this non-limiting example, stores history data 802 associated with past aid opportunities. The history data 802, such as historical data 506 in FIG. 5. The history data 802 in this example includes different aid types of aid opportunities and the items that were needed/requested for those aid types. The plurality of items 804 includes the requested items 806 and/or predicted items 808. Requested items 806 are currently needed for an event that has already occurred in the recent past. Predicted items 808 are items that are not yet needed for an event that is predicted to occur in the future.

The plurality of available providers 810 is a listing of providers of the requested items, including the selected items. The selected provider 812 includes one or more providers selected from the plurality of providers by the aid request generator to provide the selected items to the receiving party. The selected providers in some examples are selected based on a location of the provider and a location of the event associated with the aid opportunity. For example, if the event associated with the aid opportunity is a tornado that has destroyed homes in a small town, the selected providers are providers in close geographic proximity to the location of the destroyed homes.

The set of aid request rules 814 is a set of one or more rules for approving an aid request, determining priorities of items, determining priorities of deliveries, identifying locations of providers, setting deadlines, such as setting an expiration date 816. The expiration date 816 may be an expiration date for a requested items list or an expiration date for a specific item on the requested items list. The set of rules in other examples includes rules governing the location at which items may be provided/delivered, dates during which items can be provided/delivered, rules for predicting needed items, and rules for determining a priority of items on a requested items list.

In other examples, the set of aid request rules 814 include one or more rules for determining which stores or distribution center has specific inventory including the requested items, which trailers can deliver the requested items to a disaster area, which routes are open and available/most efficient, and rules for notification of parties regarding availability of items for pick-up and confirmation of items already picked-up.

For example, the set of aid request rules 814 may specify that a list of Christmas wish toys for children will remain valid for approximately a month and have an expiration date of December twenty-third while an aid request for bottled water and box fans where electricity has been lost in an apartment complex during the summer may only last for a few days or until the electricity is restored.

FIG. 9 is an exemplary flow chart illustrating operation of the computing device to update a requested items list for an aid opportunity. The process shown in FIG. 9 may be performed by an aid request generator executing on a computing device, such as, but not limited to, the computing device 102 in FIG. 1, the server 202 in FIG. 2, and/or the server 302 in FIG. 3.

The process begins by sending a requested item list to an aid request site at operation 902. The aid request site is an online website or webpage hosted on a server, such as server 126 in FIG. 1, server 202 in FIG. 2, server 302 in FIG. 3. A client device accesses the list of requested items via the aid request site to enable the user to purchase and donate requested items for the aid opportunity, such as the client device 128 in FIG. 1 and/or the client device 220 in FIG. 2.

The aid request generator determines whether one or more items from the requested items list is selected at operation 904. A selected item is an item from the requested items list that is purchased and donated to the aid opportunity by the user. If there are no selected items, the aid request generator waits a predetermined time at operation 906 before checking whether any items are selected for donation again at operation 904. The aid request generator may determine if one or more items have been selected by the user for donation from the requested items list by analyzing updates from the aid request site and/or requesting updates from the aid request site.

If one or more items are selected at operation 904, the aid request generator identifies the one or more selected items at operation 908. The aid request generator updates the requested items list based on the identified selected items at operation 910. The aid request generator determines whether any unselected items remain at operation 912. An unselected item is a requested item in the requested items list that has not yet been purchased and donated to the aid opportunity. An un-selected item is an item that remains needed by the aid opportunity.

The aid request generator determines whether one or more un-selected items remain at operation 912. An un-selected item is an item from the requested items list that has not yet been purchased by a user for donation.

If there are remaining un-selected items at operation 912, the aid request generator determines whether the requested items list is expired at operation 914. If the list is not expired (expiration date not yet reached) at operation 914, the aid request generator sends the updated requested item list to the aid request site at operation 902. Operations 902 through 914 are executed iteratively until all items on the requested items list are provided at operation 912 or the requested items list is expired at operation 914. If all the requested items are selected or the list is expired, the aid request generator removes the requested items list from the aid request site at operation 916. The process terminates thereafter.

While the operations illustrated in FIG. 9 are performed by a server or other computing device, aspects of the disclosure contemplate performance of the operations by other entities. For example, a cloud service may perform one or more of the operations. While the example operations provided herein refer to a suggested or preferred item, a suggested or preferred service may also be identified in a similar manner.

FIG. 10 is an exemplary flow chart illustrating operation of the computing device to identify providers of requested items. The process shown in FIG. 10 may be performed by an aid request generator executing on a computing device, such as, but not limited to, the computing device 102 in FIG. 1, the server 202 in FIG. 2, and/or the server 302 in FIG. 3.

The process begins by analyzing inventory of a plurality of providers at operation 1002. A provider of a set of one or more requested items is identified at operation 1004. The provider may include a distribution center, a retail store, a collection center, warehouse, or other provider having at least one requested item. A determination is made as to whether the identified provider is within a predetermined distance of a receiving party at operation 1006. In some examples, the aid request generator identifies a provider within the predetermined distance of a location of the receiving party. In other examples, the aid request generator identifies a provider within the predetermined distance of a location of an aid opportunity. The predetermined distance is a maximum distance between a location of a provider and a location of an aid opportunity or a receiving party.

If the provider is not located within the predetermined distance at operation 1006, the aid request generator notifies the provider to ship the set of requested items to a pickup location within the predetermined distance of the receiving party or the aid opportunity at operation 1008. The pickup location is transmitted to the receiving party at operation 1010. The process terminates thereafter.

If the provider is located within the predetermined distance of a receiving party at operation 1006, the location of the selected provider is transmitted to the receiving party at operation 1012. The process terminates thereafter.

While the operations illustrated in FIG. 10 are performed by a server or other computing device, aspects of the disclosure contemplate performance of the operations by other entities. For example, a cloud service may perform one or more of the operations. While the example operations provided herein refer to a suggested or preferred item, a suggested or preferred service may also be identified in a similar manner.

FIG. 11 is an exemplary flow chart illustrating operation of the computing device to pre-stage recommended items for a predicted future event. The process shown in FIG. 11 may be performed by an aid request generator executing on a computing device, such as, but not limited to, the computing device 102 in FIG. 1, the server 202 in FIG. 2, and/or the server 302 in FIG. 3.

The process begins by selecting a geographic region at 1102. The aid request generator determines if there is a predicted future event associated with the geographic region at 1104. If no, the process terminates thereafter.

If there is a predicted future event at 1104, the aid request generator generates a predicted pre-staging time-period at 1106. The aid request generator determines whether there is a predicted aid opportunity associated with the predicted event at 1108. If no, the process terminates thereafter.

If an aid opportunity associated with the predicted future event is predicted, the aid request generator identifies the type of the aid opportunity at 1110. The aid request generator identifies a pre-staging location at 1112. The aid request generator generates a list of recommended items associated with the predicted aid opportunity at 1114. The aid request generator pre-stages items in the list at the pre-staging location for the predicted pre-staging time-period at 1116. The process terminates thereafter.

While the operations illustrated in FIG. 11 are performed by a server or other computing device, aspects of the disclosure contemplate performance of the operations by other entities. For example, a cloud service may perform one or more of the operations. While the example operations provided herein refer to a suggested or preferred item, a suggested or preferred service may also be identified in a similar manner.

FIG. 12 is an exemplary flow chart illustrating operation of the computing device to verify pre-staging of recommended items in a pre-staging location. The process shown in FIG. 12 may be performed by an aid request generator executing on a computing device, such as, but not limited to, the computing device 102 in FIG. 1, the server 202 in FIG. 2, and/or the server 302 in FIG. 3.

The process begins by obtaining dynamic context data from one or more data sources at 1202. The aid request generator analyzes the dynamic context data using pattern analysis at 1204. The aid request generator generates a predicted future event predicted to occur during a predicted time-period at 1206. The aid request generator determines if items are needed or recommended at 1208. If no, the process terminates thereafter.

If one or more items are recommended for pre-staging, the aid request generator pre-stages the items at a pre-staging location at 1210. The aid request generator determines whether a verification that the items have been pre-staged at the pre-staging location has been received at 1212. If no, the aid request generator requests pre-staging verification at 1214. If the pre-staging is verified at 1212, the process terminates thereafter.

While the operations illustrated in FIG. 12 are performed by a server or other computing device, aspects of the disclosure contemplate performance of the operations by other entities. For example, a cloud service may perform one or more of the operations. While the example operations provided herein refer to a suggested or preferred item, a suggested or preferred service may also be identified in a similar manner.

FIG. 13 is an exemplary flow chart illustrating operation of the computing device to authenticate an aid opportunity. The process shown in FIG. 13 may be performed by an aid request generator executing on a computing device, such as, but not limited to, the computing device 102 in FIG. 1, the server 202 in FIG. 2, and/or the server 302 in FIG. 3.

The process begins by receiving an aid request, including aid request data, from a requesting party at operation 1302. The aid request is a request for needed items associated with an aid opportunity, such as, the aid request 306 in FIG. 3. The aid request is received by an aid request generator, such as aid request generator 112 in FIG. 1, the aid request generator 204 in FIG. 2, the aid request generator 304 in FIG. 3, and/or the aid request generator 500 in FIG. 5.

A verification component determines whether to automatically approve the aid request at operation 1304. If the requesting party is included on a list of pre-approved requesting parties and/or the aid opportunity is included in a list of pre-approved aid opportunities, the aid request is automatically approved. If the aid request is automatically approved, the requested items list corresponding to the aid request is output to aid request site at operation 1314. The process terminates thereafter.

If the aid request is not pre-approved, the verification component obtains aid opportunity data from a set of one or more sources at operation 1306. The aid opportunity data is data mined from one or more sources associated with the aid opportunity. The sources may include third-party provided information verifying a natural disaster, a holiday, an emergency, or other event corresponding to the aid opportunity. The set of sources are sources such as, the set of sources 132 in FIG. 1 and/or the plurality of data sources 410 in FIG. 4.

The verification component analyzes the obtained aid opportunity data and the aid request data using a set of aid request rules at operation 1308. The aid request data is data extracted from the aid request received from the requesting party. The aid request data identifies the aid opportunity. In some examples, the aid request data optionally includes a list of one or more requested items. The set of aid request rules includes a set of one or more rules associated with approving an aid request, identifying needed items, identifying a provider of the items in a location corresponding to the location of the aid opportunity, and/or generating requested items lists, such as the set of aid request rules 814 in FIG. 8.

The verification component determines whether to approve the aid request at operation 1310 based on the analysis results. If the analysis results indicate the aid request is associated with an approved aid opportunity and/or the requesting party is a verified charity, the verification component approves the request. If the aid request is not from a verified charity and/or the request is for an aid opportunity that cannot be verified, the aid request is rejected. In some examples, if the analysis results indicate the aid request data corresponds to aid opportunity data obtained from independent third-party sources, the request is approved.

If the request is not approved at operation 1310, the aid request generator rejects the aid request at operation 1312. In some examples, a notification or response indicating the rejection of the request is output to the third-party requester.

If the aid request is approved at operation 1310, the aid request generator outputs the requested items list corresponding to the aid request via an aid request site at operation 1314. The requested items list in other examples may be a recommended items list of items for a predicted future event.

The aid request list is a list of one or more needed items, such as the at least one requested item 122 in FIG. 1, the recommended items list 214 in FIG. 2, the requested items list 312 in FIG. 3, and/or the predicted requested items 512 in FIG. 5. The aid request site is a site providing a portal or interface enabling users to donate one or more items from the requested items list, such as the aid request site 124 in FIG. 1 and/or the portal 218 in FIG. 2. The process terminates thereafter.

While the operations illustrated in FIG. 13 are performed by a server or other computing device, aspects of the disclosure contemplate performance of the operations by other entities. For example, a cloud service may perform one or more of the operations. While the example operations provided herein refer to a suggested or preferred item, a suggested or preferred service may also be identified in a similar manner.

FIG. 14 is an exemplary flow chart illustrating operation of the computing device to generate a requested items list for a verified aid opportunity. The process shown in FIG. 14 may be performed by an aid request generator executing on a computing device, such as, but not limited to, the computing device 102 in FIG. 1, the server 202 in FIG. 2, and/or the server 302 in FIG. 3.

The process begins by receiving aid request data for an approved aid opportunity at operation 1402. The aid request data is data extracted from a request received from a requesting party. The approved aid opportunity may be a pre-authorized aid opportunity or an aid opportunity that is approved via analysis of aid request data and aid opportunity data obtained from a set of one or more sources, such as the set of sources 132 in FIG. 1 and/or the plurality of sources 410 in FIG. 4.

The aid request generator analyzes the aid request data to identify an aid type at operation 1404. In some examples, the aid request generator analyzes aid opportunity data gathered from a set of sources with the aid request data. In still other examples, the aid request generator analyzes the aid request data using one or more rules in a set of aid request rules, such as the set of aid request rules 814 in FIG. 8.

The aid request generator determines whether an aid type is identified at operation 1406. The aid type indicates what type of aid opportunity is associated with the aid request, such as the aid type 138 in FIG. 1. If no aid type is identified based on the analysis results, an error message is output at operation 1408. The error message may be output via an output device, such as the user interface component 110 in FIG. 1.

If an aid type is identified at operation 1406, a requested item list is generated based on the aid type at operation 1410. For example, if the identified aid type is a toy-donation aid type, the requested item list including popular toys for children is generated.

The aid request generator outputs the requested item list to an aid request site at operation 1412. The aid request site in some examples is an online retail site providing a portal for user access, such as the aid request site 124 in FIG. 1 and/or the portal 218 in FIG. 2. The process terminates thereafter.

While the operations illustrated in FIG. 14 are performed by a server or other computing device, aspects of the disclosure contemplate performance of the operations by other entities. For example, a cloud service may perform one or more of the operations. While the example operations provided herein refer to a suggested or preferred item, a suggested or preferred service may also be identified in a similar manner.

### Additional Examples

In some examples, an aid request engine analyzes aid opportunity data when a natural disaster or other event occurs to determine what items are needed by the affected community. The aid request engine approves or rejects aid requests from charitable organizations to ensure users can trust the recipients of the donated selected items to deliver the items to the individuals in need. The aid request engine selects one or more providers of the donated selected items that are located near the location of the natural disaster to ensure quick and efficient delivery of the items to the community impacted by the disaster.

The aid request generator in other examples provides an aid request site for posting requested item lists from requesting parties associated with an aid opportunity. The aid request site prompts the inventory allocated to a specific natural disaster, allowing uses to purchase selected items directly in one or more store(s) near the disaster area and/or purchase one or more selected items online for donation to the requesting party for utilization by an aid opportunity. A selected provider, chosen by the aid request generator, dispatches the donated selected items from the store or distribution center to the collection area in the one or more stores for pick-up by the requesting parties.

In other examples, the aid request server provides users with the ability to purchase items needed directly to the affected countries or areas through local stores and distribution centers. This ensures that donated selected items are really going to help the people in need.

The aid request site in other examples provides a webpage with a graphical icon or graphical representation of a banner indicating an aid opportunity. In one example, the banner runs along the top of the webpage. The user selects the aid opportunity icon or banner via a user interface to purchase selected items from the requested items list.

In other examples, the user interface associated with a client device provides a graphical representation of an alert at the aid request site. The alert indicates the aid opportunity. When the user selects the graphical representation of the alert, the aid request site outputs the requested items list. The requested items list is displayed to the user via the user interface, by the aid request site. The user selects one or more items from the displayed requested items list for purchase and donation to the aid opportunity. The donated selected items in some examples are directed to local stores or distribution centers near the disaster area for efficient delivery.

In other examples, the aid request generator collects data from multiple different sources, modules, and interface documents to customize inventory requirements and inventory management and verify natural disaster events in specific locations. In some examples, the aid request generator collects or aggregates data from news sources, wire feeds, social media sites, and other data sources. The analysis component analyzes the aggregated data to verify an occurrence of a natural disaster or other emergency event, identify a location of the natural disaster or other emergency event, and gather other data indicating potential needs of the disaster victims or others within a proximity to the location of the natural disaster or other emergency event.

In other examples, the aid request generator collects data from interface documents located in one or more databases, filesystems, or other data storage devices. The documents may include invoices, order forms, delivery data, item request forms, pre-approved requesting party data forms, aid opportunity history data, or other disaster relief data. This information is utilized in some examples to make more accurate predictions regarding items needed for a given aid opportunity and/or verify an aid opportunity exists for approving or denying aid requests.

In still other examples, the aid request generator collects data from one or more remote modules located on one or more remote computing devices, such as remote servers, remote data storage systems, remote file systems, and/or remote client devices. The remote modules may include remote machine learning or remote aid request data analysis modules. The modules provide analysis results, predictions of needed items, current inventory, needed items in inventory, location of stores or warehouses providing donated items, etc. In this manner, the aid request generator may obtain needed analysis results or machine learning predictions generated remotely from the aid request generator.

The inventory is allocated by the aid request generator, in some examples, based on the analytic system providing data collected from the different data feeds, modules, databases, and interface documents after verification of a specific natural disaster reported by a third-party aid agency web server requesting the aid. The aid request generator confirms the items needed for relief in the specified natural disaster by analyzing user provided data, aid opportunity data, and/or aid request data.

In yet other examples, the aid request generator uses machine learning to predict future needs in the form of predicted future aid requested items which may be needed for natural disasters that are likely to occur at certain times of year, in certain locations (hurricane season, tornado season). The aid request generator sends notifications to providers regarding these predicted/anticipated needs. The providers are then enabled to increase inventory in those areas in preparation for the predicted events.

In other examples, the providers of the donated selected items deliver the donated selected items via pre-staged trailers. A pre-staged trailer is a trailer that is loaded with items that are predicted to be needed for a predicted, future aid opportunity where disaster/needs are likely to occur. The aid request generator informs inventory management systems to stock up for relief in these predicted, future need areas.

Donated items unavailable in local stores near a disaster area are shipped from nearby distribution centers that have the needed items to the nearest store to disaster or to the nearest distribution center, in other examples.

In other examples, the aid request site provides an aid agency or other requesting party with instant, real-time view into what items are being donated by users, when the items will be available for pick-up, and where the items can be collect/picked-up. The system may also send notifications/reminders to the requesting parties and/or receiving parties to come collect the items from the designate pick-up location.

One example provides a system to facilitate online distribution of items for a disaster affected area. The system allows non-profit organizations to provide a list of items needed to be supplied by donations from the public. The system allows users to select a location and items to donate online. The system communicates the donated items to a store or other provider.

Alternatively, or in addition to the other examples described herein, examples include any combination of the following:
the plurality of data sources includes at least one of news feeds, social media feeds, weather feeds, and emergency alert feeds;
a user interface component, implemented on the at least one processor, that outputs the generated list of items to an aid request site;
the output list of items accessible to users of the aid request site for direct purchase of selected items from the list of items for donation in response to occurrence of the predicted aid opportunity;
a notification component, implemented on the at least one processor, outputs a pre-staged items list to at least one user device via the network on condition the plurality of data sources indicates the occurrence of the predicted future event within the selected geographic area;
the user interface component provides a graphical representation of an alert on the aid request site indicating the aid opportunity, such that upon user selection of the graphical representation of the alert the list of items is displayed on the aid request site;
the analysis component processes data associated with the aid opportunity including static data and dynamic data;
the analysis component is trained using historical event data and historical aid data, including information associated with a plurality of disaster types, a plurality of need types, a plurality of aid types, emergency personnel data, a plurality of product types, environmental condition data, geographic location data, and demographic location data;
the analysis component further stores processed data, including the list of items in a data storage device, wherein the aid opportunity prediction component generates predicted future aid opportunities based at least in part on the stored data;
the verification component, implemented on the at least one processor, receives data associated with an identified aid opportunity which has already occurred;
the verification component, implemented on the at least one processor, automatically mines the plurality of data sources to authenticate the identified aid opportunity;
the analysis component, implemented on the at least one processor, processes the received data associated with the identified aid opportunity;
the analysis component, implemented on the at least one processor, identifies an aid opportunity type and generate a list of items based on the identified aid opportunity type;
the user interface component further provides a portal corresponding to the aid opportunity, the portal providing real-time information about the set of items to an agency associated with the predicted aid opportunity on the occurrence of the predicted future event;
analyzing data obtained from at least one of news feeds, social media feeds, weather feeds, or emergency alert feeds to validate an aid opportunity associated with an event associated with a request from a requesting party;
responsive to failure to validate the aid opportunity, requesting approval from an authorized user;
responsive to receiving approval from the authorized user, verifying the aid opportunity, wherein the requesting party is authorized to request donation of items associated with the aid opportunity;
responsive to receiving a rejection from the authorized user, outputting a response to requesting party indicating the aid opportunity is unverified;
generating a notification to an agency associated with the aid opportunity type, the notification including the list of items pre-staged at the pre-staging location;
identifying a provider supplying at least one item in the list of items located within a predetermined distance of the pre-staging location;
receiving aid request data associated with an aid opportunity;
determining whether the received aid request data is authenticated;
responsive to authenticating the received aid request data, verifying the aid opportunity using a plurality of data sources;
processing the received aid request data associated with the verified aid opportunity to identify an aid type;
generating a requested items list based on the identified aid type;
outputting the generated requested items list to an aid request site, the aid request site having inventory corresponding to the output requested items list, the output requested items list accessible to users of the aid request site for direct purchase of selected items from the output requested items list by the users for donation of the selected items to the verified aid opportunity;
the pre-staging location includes two or more storage locations within a predetermined distance from the predicted location of the predicted future event;
outputting the generated list of items to a supplier for inventory preparation;
a user device associated with an authorized user, wherein the aid request generator sends a notification requesting approval for pre-staging the set of items from the authorized user;
a set of sensor devices associated with the pre-staging storage area, wherein the set of sensor devices generates sensor data associated with the set of items, wherein the aid request generator analyzes the sensor data to verify pre-staging of the set of items in the list of items is completed;
the selected items are delivered directly from a provider associated with the aid request site to an agency associated with the aid opportunity;
the selected items are identified at a provider associated with the aid request site and having a geographic location corresponding to the aid opportunity;
the user interface component provides a graphical representation of an alert at the aid request site, the alert indicating the aid opportunity, such that upon user selection of the graphical representation of the alert the output requested items list is displayed at the aid request site;
the analysis component processes the received data associated with the aid opportunity using static data and dynamic data;
the analysis component is trained using past aid data, including information associated with a plurality of disaster types, a plurality of need types, a plurality of aid types, emergency personnel data, a plurality of product types, environmental condition data, geographic location data, and demographic location data;
the analysis component further stores the processed data, including the generated requested items list, at a data storage location;
a prediction component that predicts upcoming aid opportunities based at least in part on the stored data;
the prediction component outputs the predicted upcoming aid opportunities to the analysis component, the analysis component identifying a future aid type for a predicted aid opportunity, generating a future aid requested items list based on identified future aid type, and outputting the generated future aid requested items list to a provider for inventory preparation;
the user interface component further provides a portal corresponding to the aid opportunity, the portal providing real-time information about the selected items to an agency associated with the aid opportunity;
determining whether the aid opportunity can be validated using at least one of news feeds, social media feeds, weather feeds, or emergency alert feeds;
requesting approval from an authorized user in response to determining that the aid opportunity cannot be validated using at least one of the news feeds, the social media feeds, the weather feeds, or the emergency alert feeds;
verifying the aid opportunity in response to receiving approval from an authorized user;
outputting a response to the data input that the aid opportunity is unverified in response to receiving a rejection from the authorized user;
generating a notification corresponding to the selected items, the notification output from a provider associated with the aid request site to an agency associated with the aid opportunity;
locating the selected items at a provider that is associated with the aid request site and has a geographic location corresponding to the aid opportunity;
providing a graphical representation of an alert at the aid request site, the alert indicating the aid opportunity, such that upon user selection of the graphical representation of the alert the output requested items list is displayed at the aid request site;
storing the processed data, including the generated requested items list, at a data storage location; and predicting an upcoming aid opportunity based at least in part on the stored data;
identifying a future aid type associated with the predicted upcoming aid opportunity;
generating a future aid requested items list based on identified future aid type;
outputting the generated future aid requested items list to a provider for inventory preparation;
determining whether the aid opportunity can be validated using at least one of news feeds, social media feeds, weather feeds, or emergency alert feeds;
responsive to determining that the aid opportunity cannot be validated using at least one of the news feeds, the social media feeds, the weather feeds, or the emergency alert feeds, requesting approval from an authorized user;
responsive to receiving approval from an authorized user, verifying the aid opportunity;
responsive to receiving a rejection from the authorized user, outputting a response to the data input that the aid opportunity is unverified;
generating a notification corresponding to the selected items, the notification output from a provider associated with the aid request site to an agency associated with the aid opportunity;
the selected items are delivered directly from a provider associated with the aid request site to an agency associated with the aid opportunity;
the selected items are identified at a provider associated with the aid request site and having a geographic location corresponding to the aid opportunity;
the user interface component provides a graphical representation of an alert at the aid request site, the alert indicating the aid opportunity, such that upon user selection of the graphical representation of the alert the output requested items list is displayed at the aid request site;
the analysis component processes the received data associated with the aid opportunity using static data and dynamic data;
the analysis component is trained using past aid data, including information associated with a plurality of disaster types, a plurality of need types, a plurality of aid types, emergency personnel data, a plurality of product types, environmental condition data, geographic location data, and demographic location data;
the analysis component further stores the processed data, including the generated requested items list, at a data storage location;
a prediction component that predicts upcoming aid opportunities based at least in part on the stored data;
the prediction component outputs the predicted upcoming aid opportunities to the analysis component, the analysis component identifying a future aid type for a predicted aid opportunity, generating a future aid requested items list based on identified future aid type, and outputting the generated future aid requested items list to a provider for inventory preparation; and/or
the user interface component further provides a portal corresponding to the aid opportunity, the portal providing real-time information about the selected items to an agency associated with the aid opportunity.

At least a portion of the functionality of the various elements in FIG. 1, FIG. 2, FIG. 3, FIG. 4, FIG. 5, FIG. 6, FIG. 7 and FIG. 8 may be performed by other elements in FIG. 1, FIG. 2, FIG. 3, FIG. 4, FIG. 5, FIG. 6, FIG. 7 and FIG. 8 or an entity (e.g., processor, web service, server, application program, computing device, etc.) not shown in FIG. 1, FIG. 2, FIG. 3, FIG. 4, FIG. 5, FIG. 6, FIG. 7 and FIG. 8.

In some examples, the operations illustrated in FIG. 9, FIG. 10, FIG. 11, FIG. 12, FIG. 13 and FIG. 14 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform selected tasks or implement abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for coordinating targeted charitable aid. For example, the elements illustrated in FIG. 1, FIG. 2, FIG. 3, FIG. 4, FIG. 5, FIG. 6, FIG. 7 and FIG. 8 such as when encoded to perform the operations illustrated in FIG. 9, FIG. 10, FIG. 11, FIG. 12, FIG. 13 and FIG. 14, constitute exemplary means for receiving data input associated with an aid opportunity, the data input including aid request data and/or aid opportunity data; exemplary means for determining whether the received data input is authenticated; exemplary means for verifying the aid opportunity using a plurality of sources in response to authenticating the received data input; exemplary means for processing the received data input associated with the verified aid opportunity to identify an aid type; exemplary means for generating a requested items list based on the identified aid type; and exemplary means for outputting the generated requested items list to an aid request site having inventory corresponding to the output requested items list.

In another example, the elements illustrated in FIG. 1, FIG. 2, FIG. 3, FIG. 4, FIG. 5, FIG. 6, FIG. 7 and FIG. 8 such as when encoded to perform the operations illustrated in FIG. 9, FIG. 10, FIG. 11, FIG. 12, FIG. 13 and FIG. 14, constitute exemplary means for obtaining dynamic context data from a plurality of data sources via a network; exemplary means for analyzing the dynamic context data and historical event-related data associated with a selected geographic area using pattern analysis; exemplary means for generating a predicted future event within the selected geographic region and a predicted time-period for pre-staging items prior to an occurrence of the predicted future event; exemplary means for identifying a predicted aid opportunity associated with the predicted future event and an aid opportunity type of the predicted aid opportunity; exemplary means for generating a list of items predicted to be requested on condition the predicted future event transpires within the predicted time-period based on previous requested items associated with historical events of the identified aid opportunity type; exemplary means for identifying a pre-staging location within a predetermined distance from the selected geographic area; exemplary means for routing a set of items identified in the list of items predicted to be requested to a storage area associated with the identified pre-staging location during the predicted time-period; and exemplary means for verifying pre-staging of the set of items within the storage area at the identified pre-staging location within the predicted time-period based on sensor data obtained from a plurality of sensor devices associated with the pre-staging location.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing an operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for coordinating targeted charitable aid, the system comprising:
a memory;
at least one processor communicatively coupled to the memory;
a plurality of data sources generating dynamic context data associated with a selected geographic area;
an aid opportunity prediction component, implemented on the at least one processor, obtains the dynamic context data via a network;
the aid opportunity prediction component, implemented on the at least one processor, generates a predicted future event within the selected geographic area and a predicted time-period for pre-staging items prior to an occurrence of the predicted future event based on an analysis of the dynamic context data using pattern analysis and historical event-related data associated with the selected geographic area;
an analysis component, implemented in the at least one processor, identifies a predicted aid opportunity associated with the predicted future event and an aid opportunity type of the predicted aid opportunity;
an item identification component, implemented in the at least one processor, generates a list of items predicted to be requested on condition the predicted future event transpires within the predicted time-period based on historical requested items associated with historical events of the predicted aid opportunity type;
a location identification component, implemented on the at least one processor, identifies a pre-staging location within a predetermined distance from the selected geographic area;
a pre-staging component, implemented on the at least one processor, routes a set of items identified in the list of items predicted to be requested to a storage area associated with the identified pre-staging location during the predicted time-period; and
a verification component, implemented on the at least one processor, verifies presence of the set of items within the storage area at the identified pre-staging location within the predicted time-period based on sensor data obtained from a set of sensor devices associated with the pre-staging location.

2. The system of claim 1, wherein the plurality of data sources includes at least one of news feeds, social media feeds, weather feeds, and emergency alert feeds.

3. The system of claim 1, further comprising:
a user interface component, implemented on the at least one processor, that outputs the generated list of items to an aid request site, the output list of items accessible to users of the aid request site for direct purchase of selected items from the list of items for donation in response to occurrence of the predicted aid opportunity.

4. The system of claim 1, further comprising:
a notification component, implemented on the at least one processor, outputs a pre-staged items list to at least one user device via the network on condition the plurality of data sources indicates the occurrence of the predicted future event within the selected geographic area.

5. The system of claim 1, wherein the user interface component provides a graphical representation of an alert on the aid request site indicating the aid opportunity, such that upon user selection of the graphical representation of the alert the list of items is displayed on the aid request site.

6. The system of claim 1, wherein the analysis component processes data associated with the aid opportunity including static data and dynamic data.

7. The system of claim 1, wherein the analysis component is trained using historical event data and historical aid data, including information associated with a plurality of disaster types, a plurality of need types, a plurality of aid types, emergency personnel data, a plurality of product types, environmental condition data, geographic location data, and demographic location data.

8. The system of claim 1, wherein the analysis component further stores processed data, including the list of items in a data storage device, wherein the aid opportunity prediction component generates predicted future aid opportunities based at least in part on the stored data.

9. The system of claim 8, further comprising:
the verification component, implemented on the at least one processor, receives data associated with an identified aid opportunity which has already occurred;
the verification component, implemented on the at least one processor, automatically mines the plurality of data sources to authenticate the identified aid opportunity;
the analysis component, implemented on the at least one processor, processes the received data associated with the identified aid opportunity; and
the analysis component, implemented on the at least one processor, identifies an aid opportunity type and generate a list of items based on the identified aid opportunity type.

10. The system of claim 1, wherein the user interface component further provides a portal corresponding to the aid opportunity, the portal providing real-time information about the set of items to an agency associated with the predicted aid opportunity on the occurrence of the predicted future event.

11. A computer-implemented method for coordinating targeted charitable aid, the computer-implemented method comprising:
obtaining, by an aid opportunity prediction component, dynamic context data from a plurality of data sources via a network;
analyzing the dynamic context data and historical event-related data associated with a selected geographic area using pattern analysis;
generating a predicted future event within the selected geographic area and a predicted time-period for pre-staging items prior to an occurrence of the predicted future event;
identifying, by an analysis component, a predicted aid opportunity associated with the predicted future event and an aid opportunity type of the predicted aid opportunity;
generating, by an item identification component, a list of items predicted to be requested on condition the predicted future event transpires within the predicted time-period based on previous requested items associated with historical events of the identified aid opportunity type;
identifying, by a location identification component, a pre-staging location within a predetermined distance from the selected geographic area; and
verifying, by a verification component, pre-staging of the set of items within the storage area at the identified pre-staging location within the predicted time-period based on sensor data obtained from a set of sensor devices associated with the pre-staging location.

12. The computer-implemented method of claim 11, further comprising:
analyzing data obtained from at least one of news feeds, social media feeds, weather feeds, or emergency alert feeds to validate an aid opportunity associated with an event associated with a request from a requesting party;
responsive to failure to validate the aid opportunity, requesting approval from an authorized user;
responsive to receiving approval from the authorized user, verifying the aid opportunity, wherein the requesting party is authorized to request donation of items associated with the aid opportunity; and
responsive to receiving a rejection from the authorized user, outputting a response to requesting party indicating the aid opportunity is unverified.

13. The computer-implemented method of claim 11, further comprising:
generating a notification to an agency associated with the aid opportunity type, the notification including the list of items pre-staged at the pre-staging location.

14. The computer-implemented method of claim 11, further comprising:
identifying a provider supplying at least one item in the list of items located within a predetermined distance of the pre-staging location.

15. The computer-implemented method of claim 11, further comprising:
receiving aid request data associated with an aid opportunity;
determining whether the received aid request data is authenticated;
responsive to authenticating the received aid request data, verifying the aid opportunity using a plurality of data sources;
processing the received aid request data associated with the verified aid opportunity to identify an aid type;
generating a requested items list based on the identified aid type; and outputting the generated requested items list to an aid request site, the aid request site having inventory corresponding to the output requested items list, the output requested items list accessible to users of the aid request site for direct purchase of selected items from the output requested items list by the users for donation of the selected items to the verified aid opportunity.

16. The computer-implemented method of claim 11, further comprising:
routing, by a pre-staging component, a set of items identified in the list of items predicted to be requested to a storage area associated with the identified pre-staging location during the predicted time-period.

17. The computer-implemented method of claim 16, further comprising:
outputting the generated list of items to a supplier for inventory preparation.

18. A system for pre-staging items for targeted charitable aid, the system comprising:
a memory;
at least one processor communicatively coupled to the memory;
a plurality of data sources generating dynamic context data associated with a selected geographic area;
an aid request generator component, implemented on the at least one processor, analyzes the dynamic context data to identify an aid opportunity and an aid opportunity type;
a communications interface device outputs a list of recommended items for pre-staging in preparation for an occurrence of the aid opportunity based on the identified aid opportunity type; and
a pre-staging component, implemented by the at least one processor, routes a set of items identified in the list of recommended items to the storage area associated with a pre-staging location within a predetermined distance of a predicted location for the predicted future event for storage during a predicted pre-staging time-period prior to occurrence of the predicted future event.

19. The system of claim 18, further comprising:
a user device associated with an authorized user, wherein the aid request generator sends a notification requesting approval for pre-staging the set of items from the authorized user.

20. The system of claim 18, further comprising:
a set of sensor devices associated with the pre-staging storage area, wherein the set of sensor devices generates sensor data associated with the set of items, wherein the aid request generator analyzes the sensor data to verify pre-staging of the set of items in the list of items is completed.
